(19) United States
(12) Patent Application Publication
(10) Pub. No.: US 2023/0415696 A1
(43) Pub. Date: Dec. 28, 2023

(54) LEVER RELEASE MID-BELT ADJUSTER

(71) Applicant: Indiana Mills & Manufacturing, Inc., Westfield, IN (US)

(72) Inventor: Brian Nelson Coffman, Westfield, IN (US)

(73) Assignee: Indiana Mills & Manufacturing, Inc., Westfield, IN (US)

(21) Appl. No.: 18/459,060

(22) Filed: Aug. 31, 2023

Related U.S. Application Data
(63) Continuation of application No. PCT/US2022/070913, filed on Mar. 2, 2022.
(60) Provisional application No. 63/200,336, filed on Mar. 2, 2021.

(51) Int. Cl. B60R 22/30; A44B 11/10; A44B 11/06

(52) U.S. Cl. CPC B60R 22/30; A44B 11/10; A44B 11/065

(57) ABSTRACT

A belt adjuster configured to secure a belt of a child car seat. The belt is squeezed and/or compressed between a belt bar and a frame to prevent movement of the belt. The belt adjuster includes a trigger configured to function as a lever. In one example, the lever extends from a belt bar to the trigger, such that force applied to the trigger actuates the belt bar. The lever is configured to multiply a force applied to the trigger to reduce the force needed to release the belt. In one embodiment, a force vector applied to the trigger is in a parallel and opposite direction from a force vector of the belt bar. In another embodiment, a force vector applied to the trigger is in a parallel and/or transverse direction from a force vector of the belt bar.

### CROSS REFERENCE TO RELATED APPLICATIONS

This application is a continuation of International Patent Application Number PCT/US2022/070913, filed Mar. 2, 2022, which is hereby incorporated by reference. International Patent Application Number PCT/US2022/070913, filed Mar. 2, 2022, claims the benefit of U.S. Patent Application No. 63/200,336, filed Mar. 2, 2021, which are hereby incorporated by reference.

### BACKGROUND

In child safety seats and other vehicular restraint systems, it can be difficult to properly tighten and/or loosen the belts in the vehicle. For example, in Isofix or Lower Anchors and Tethers for Children (LATCH) systems, an adjustable belt is typically used to secure the child safety seat to the lower anchors and/or the tether anchors inside the vehicle. If the belt is too loose or otherwise improperly secured, the seat may not properly function during an accident. Conversely, with such high tensions applied to the belts that are used to secure the seat, it can be difficult to loosen or otherwise release the belts.

Thus, there is a need for improvement in this field.

### SUMMARY

A unique belt adjuster system has been developed that utilizes a lever adjuster for tightening and loosening belts. As compared to other types adjusters, such as pushbutton adjusters, the lever adjuster is easier to use and requires less force in order to release the belt. For typical middle belt (or mid-belt) adjusters, such as a push button type adjuster, the adjuster automatically locks the belt in place when tension is applied to the belt so as to prevent releasing or extension of the belt. When the belts are under tension, pushbutton adjusters require a strong pressing force against at pushbutton in order to release the tension in the belts. Once the adjuster releases the belt, the user is able to pull on and extend the belt so as to loosen the belt. With less effort, the lever adjuster uses a force multiplying lever to release tension in the belts. In other words, the lever action facilitated by the lever adjuster reduces the force needed to release the belt. For instance, the required force to actuate the lever in the present lever adjuster may be roughly 30% of the equivalent force required to release the belt in a standard pushbutton belt adjuster. Of course, in other examples, the required relative force may be different. In one particular form, the lever in the adjuster is a type 1 lever that magnifies the force applied by the user on the lever.

In one version, the lever includes one or more pivot pins that pivotally engaged in openings defined in a housing or cover of the adapter. The relative location of the pivot pins along the lever generally defines how much force needs to be applied in order to release the belt from the adjuster. Other designs can include other types of pivot points, like pivot pins or shafts, that facilitate pivotal movement of the lever. At one end, the lever includes the engagement portion or trigger where the user actuates the lever, and the opposite end of the lever engages a cross bar around which the belt is looped. The looped belt further extends through a window in a frame, and the cross bar is slidably disposed along the frame. The belt becomes locked in the adapter when the cross bar squeezes the belt against one end of the frame. To release the belt, the cross bar moves away from the end of the frame so as to form a slight gap that allows the belt to slide. In one form, the end of the lever is received in one or more notches in the cross bar such that lever is able to move the cross bar relative to the frame. In this example, the pivot pins are located between the end of the lever with the trigger and the end of the lever engaging the notches in the cross bar. With such a construction, the force required to actuate the cross bar so as to release the belt is reduced. In one form, the cross bar and the frame are formed from stamped metal. The lever in one form is made of plastic. With the lever made of plastic, which is an insulator, the risk of burns or discomfort when actuating the trigger is reduced.

Given the lever adjuster requires less force to release the belt as compared to other types of adjusters, like pushbutton adjusters, it was discovered that the lever adjuster at times was more prone to accidental or inadvertent releasing of tension or engagement of the belt. To address this issue, the adjuster includes a shroud that reduces the risk of accidental actuation of the lever. In one embodiment, the lever includes the engagement portion or trigger where the user actuates the lever, such as via a pressing action, to release the belt. The housing or cover of the adjuster has a shroud that generally surrounds the trigger area of the lever. The shroud at least in part surrounds the trigger to prevent accidental actuation. In one form, the trigger area of the lever is generally flush with the shroud, and in another form, the trigger is recessed within the shroud. In still yet another form, part of the trigger is exposed outside of the shroud, but the length or size of the part that is exposed is insufficient to release the belt from the adapter. In this example, if the exposed part was press to be generally flush with the shroud, the adjuster still does not release the belt. In order to release the belt, the exposed part of the trigger needs to be pressed further inside of the shroud. In one form, the lever is biased by a spring to further prevent accidental release of the belt.

As compared to other types of adjusters, the lever of the adjuster allows the adjuster to be actuated in different orientations and directions relative to the tensioned belt or load. For instance, pushbutton type adapter designs require the user to push the button is a direction generally parallel to the belt that at least initially further tightens the belt (i.e., a tightening direction) such that the cross bar no longer squeezes the belt against the frame. In one form, the lever is configured such that the trigger is pushed in the opposite direction that the cross bar travels when releasing the belt. In other words, the actuation direction for the trigger is opposite the load direction. In another example, the lever is bent such that the trigger is pressed or otherwise actuated in a direction that is transverse or perpendicular to the belt or load. This transverse actuation direction can further reduce the force required to release the belt tension. In one form, the lever extends perpendicular relative to the frame and the crossbar assembly, and in another form, the lever extends generally parallel to the frame and crossbar assembly. As should be recognized, the lever facilitates the trigger to be oriented at other angles, such as oblique or acute angles, relative to the frame-crossbar assembly and/or the belt.

The design of the adjuster also simplifies assembly and reduces the number of parts required to manufacture the adjuster. For example, the cover and/or housing of the adjuster can include frame centering structures for orienting and aligning the frame during assembly.

The system and techniques as described and illustrated herein concern a number of unique and inventive aspects. Some, but by no means all, of these unique aspects are summarized below.

Aspect 1 generally concerns a system.

Aspect 2 generally concerns the system of any previous aspect including a belt adjuster.

Aspect 3 generally concerns the system of any previous aspect in which the belt adjuster configured to secure and release a belt.

Aspect 4 generally concerns the system of any previous aspect in which the belt adjuster configured to reduce force required to release a belt.

Aspect 5 generally concerns the system of any previous aspect in which the belt adjuster reduces the force required to release the belt by at least 20%.

Aspect 6 generally concerns the system of any previous aspect in which the belt adjuster includes a sight window configured to enable visual confirmation of belt retention.

Aspect 7 generally concerns the system of any previous aspect including a frame.

Aspect 8 generally concerns the system of any previous aspect in which the frame defines a window.

Aspect 9 generally concerns the system of any previous aspect in which the frame configured to retain a belt.

Aspect 10 generally concerns the system of any previous aspect including a belt bar.

Aspect 11 generally concerns the system of any previous aspect in which the belt bar configured to retain the belt.

Aspect 12 generally concerns the system of any previous aspect in which the belt bar moveable relative to the frame to secure and release the belt.

Aspect 13 generally concerns the system of any previous aspect in which the belt is secured between the frame and the belt bar to prevent movement of the belt.

Aspect 14 generally concerns the system of any previous aspect in which the belt is secured when the belt is compressed between the belt bar and the frame.

Aspect 15 generally concerns the system of any previous aspect in which the belt is released when the belt bar and the frame are spaced apart to form a gap where the belt is able to slide.

Aspect 16 generally concerns the system of any previous aspect in which the belt bar defines a notch where the engagement portion of the lever is received.

Aspect 17 generally concerns the system of any previous aspect including a lever.

Aspect 18 generally concerns the system of any previous aspect in which the lever coupled to the belt bar.

Aspect 19 generally concerns the system of any previous aspect in which the lever configured to actuate the belt bar to release the belt.

Aspect 20 generally concerns the system of any previous aspect in which the lever is configured to actuate the belt bar via a pivoting motion.

Aspect 21 generally concerns the system of any previous aspect in which the lever is configured to multiply the force applied to the trigger to reduce the force required to release the belt.

Aspect 22 generally concerns the system of any previous aspect in which the bar engagement portion configured to engage the belt bar.

Aspect 23 generally concerns the system of any previous aspect in which the lever is straight.

Aspect 24 generally concerns the system of any previous aspect in which the lever is bent.

Aspect 25 generally concerns the system of any previous aspect in which the lever is L-shaped.

Aspect 26 generally concerns the system of any previous aspect in which the lever has a trigger.

Aspect 27 generally concerns the system of any previous aspect in which the lever has one or more pivot pins.

Aspect 28 generally concerns the system of any previous aspect in which the lever is a type 1 lever.

Aspect 29 generally concerns the system of any previous aspect including a trigger.

Aspect 30 generally concerns the system of any previous aspect in which the trigger is where the lever is actuated.

Aspect 31 generally concerns the system of any previous aspect in which the trigger is configured to move parallel to a movement direction of the belt bar.

Aspect 32 generally concerns the system of any previous aspect in which the trigger is configured to move in an opposite direction from the movement direction of the belt bar.

Aspect 33 generally concerns the system of any previous aspect in which the trigger is configured to move perpendicular to a movement direction of the belt bar.

Aspect 34 generally concerns the system of any previous aspect in which the trigger extends transverse to the to the bar engagement portion.

Aspect 35 generally concerns the system of any previous aspect including a fulcrum.

Aspect 36 generally concerns the system of any previous aspect in which the fulcrum where the lever pivots.

Aspect 37 generally concerns the system of any previous aspect in which the fulcrum is disposed between the trigger and the bar engagement portion.

Aspect 38 generally concerns the system of any previous aspect in which the fulcrum includes one or more pivot pins.

Aspect 39 generally concerns the system of any previous aspect in which the trigger, the fulcrum, and the bar engagement portion are aligned in a substantially straight line along a longitudinal axis.

Aspect 40 generally concerns the system of any previous aspect including a shroud disposed around the trigger to inhibit accidental actuation of the lever.

Aspect 41 generally concerns the system of any previous aspect in which the trigger is recessed in the shroud.

Aspect 42 generally concerns the system of any previous aspect in which the trigger is substantially flush with the shroud.

Aspect 43 generally concerns the system of any previous aspect including a spring biasing the lever to secure the belt.

Aspect 44 generally concerns the system of any previous aspect including a cover.

Aspect 45 generally concerns the system of any previous aspect in which the cover housing the frame and the belt bar.

Aspect 46 generally concerns the system of any previous aspect in which the cover defining one or more sockets where the pivot pins are pivotally disposed.

Aspect 47 generally concerns the system of any previous aspect in which the cover has a shroud covering at least part of the trigger to inhibit accidental actuation of the lever.

Aspect 48 generally concerns the system of any previous aspect including the belt.

Aspect 49 generally concerns the system of any previous aspect including a fixed belt.

Aspect 50 generally concerns the system of any previous aspect including an adjustment belt.

Aspect 51 generally concerns the system of any previous aspect in which the belt is looped around the belt bar.

Aspect 52 generally concerns the system of any previous aspect in which the belt extends through the window in the frame.

Aspect 53 generally concerns a method of operating the system of any previous aspect.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of a belt system.

FIG. 2 is a rear perspective view of a belt adjuster of FIG. 1.

FIG. 3 is a front perspective view of the belt adjuster of FIG. 1.

FIG. 4 is a rear view of the belt adjuster of FIG. 1.

FIG. 5 is a front view of the belt adjuster of FIG. 1.

FIG. 6 is a first side view of the belt adjuster of FIG. 1.

FIG. 7 is a second side view of the belt adjuster of FIG. 1.

FIG. 8 is a top view of the belt adjuster of FIG. 1.

FIG. 9 is a bottom view of the belt adjuster of FIG. 1.

FIG. 10 is a top exploded view of the belt adjuster of FIG. 1.

FIG. 11 is a cross-sectional view of the belt adjuster of FIG. 1 as taken along line 11-11 in FIG. 8.

FIG. 12 is a bottom view of a retention assembly.

FIG. 13 is a top view of the retention assembly of FIG. 12.

FIG. 14 is a perspective view of an adjustment assembly of the belt adjuster.

FIG. 15 is a side view of the adjustment assembly of FIG. 14.

FIG. 16 is a cross-sectional view of the belt adjuster including a lever adjuster as taken along line 16-16 in FIG. 8.

FIG. 17 is a perspective view of a belt system.

FIG. 18 is a front perspective view of a belt adjuster of FIG. 17.

FIG. 19 is a rear perspective view of the belt adjuster of FIG. 17.

FIG. 20 is a front view of the belt adjuster of FIG. 17.

FIG. 21 is a rear view of the belt adjuster of FIG. 17.

FIG. 22 is a first side view of the belt adjuster of FIG. 17.

FIG. 23 is a second side view of the belt adjuster of FIG. 17.

FIG. 24 is a top view of the belt adjuster of FIG. 17.

FIG. 25 is a bottom view of the belt adjuster of FIG. 17.

FIG. 26 is an exploded view of the belt adjuster of FIG. 17.

FIG. 27 is a top exploded view of the belt adjuster of FIG. 17.

FIG. 28 is a rear perspective view of the belt adjuster without a cover.

FIG. 29 is a front perspective view of the belt adjuster without the cover.

FIG. 30 is a perspective view of an adjustment assembly.

FIG. 31 is a bottom perspective view of the adjustment assembly.

FIG. 32 is a side view of the adjustment assembly.

FIG. 33 is a bottom perspective view of the cover.

FIG. 34 is a top perspective view of the belt adjuster without the cover.

FIG. 35 is a top view of the belt adjuster without the cover.

FIG. 36 is a cross-sectional view of the belt adjuster including a lever adjuster as taken along line 36-36 in FIG. 24.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

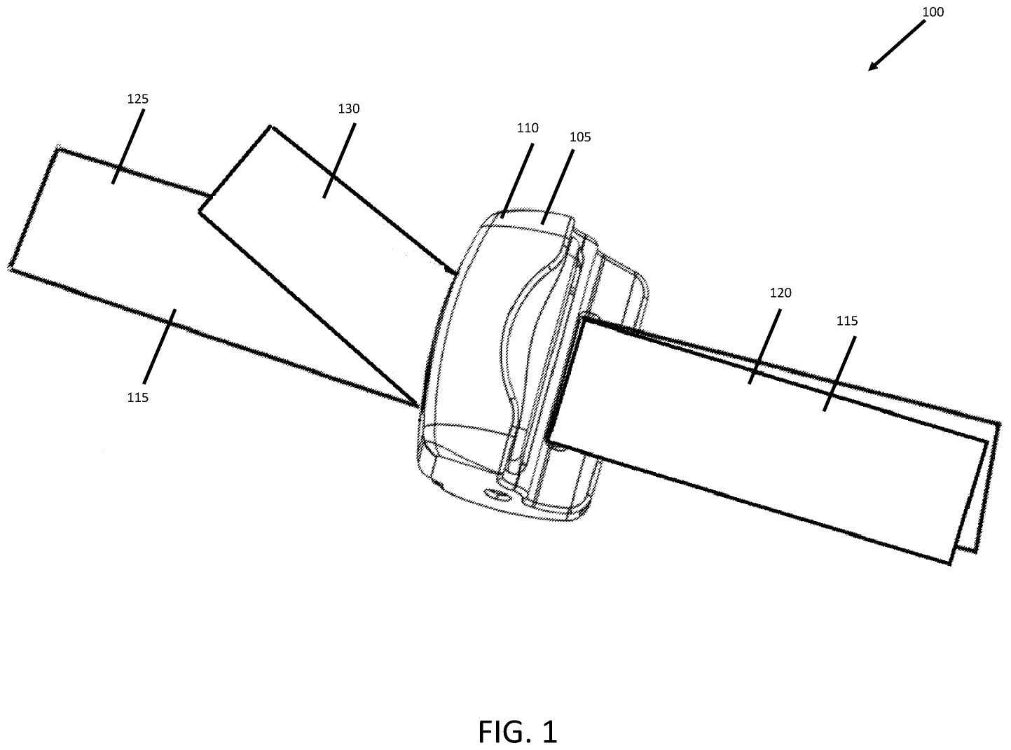

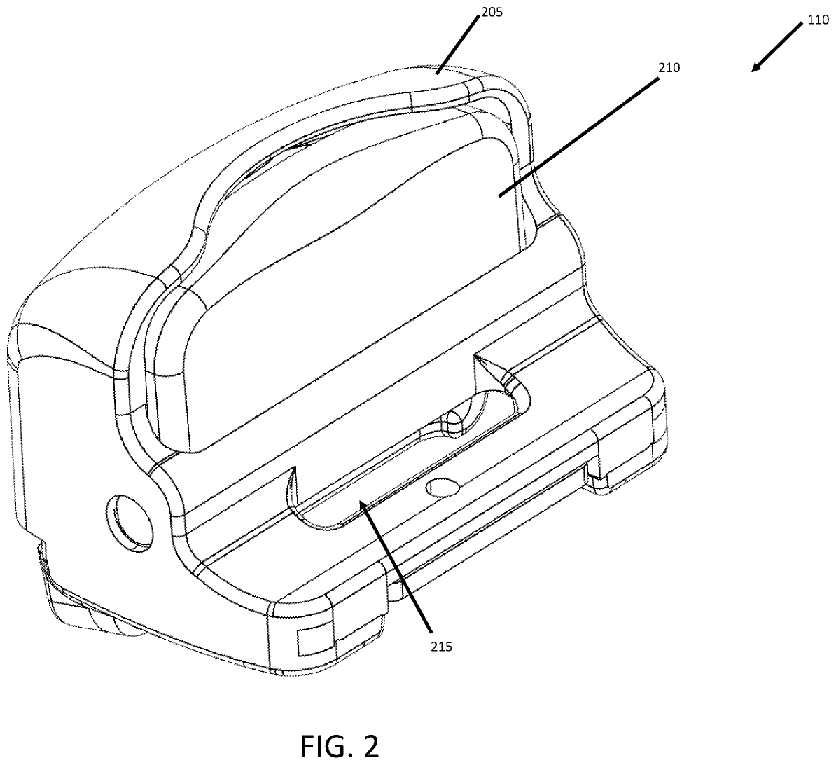

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

FIG. 1 shows an example of a belt system 100. The belt system 100 includes a belt adjuster 105. In one example, the belt adjuster 105 is in the form of a lever adjuster 110. The lever adjuster 110 is configured to reduce the amount of force required to release a belt 115. The lever adjuster 110 is generally used an adjustment mechanism for a child safety seat. In one example, the lever adjuster 110 is used to adjusted a length of one or more belts 115 to properly secure the child safety seat. As should be appreciated, some belt adjusters require large amounts of force to release the belt when the belt is under tension. Utilizing the lever adjuster 110, requires less force to release the belt 115.

The lever adjuster 110 generally connects to one or more belts 115. In one example, the belts 115 are in the form of tubular webbing. In another example, the belts 115 are in the form of rope, chains, cables, fabric, and/or other material. For example, the lever adjuster 110 has a fixed connection to a fixed belt 120. In one example, the fixed belt 120 is configured to extend between the child safety seat and the lever adjuster 110. Generally, the fixed belt 120 has a preset length and is not adjustable. However, in other examples, the fixed belt 120 has an adjustable length. The lever adjuster 110 is further removably connected to a tension belt 125. In one example, the tension belt 125 is adjustable via a belt adjuster end 130. For example, a user may pull on the belt adjuster end 130 to reduce the length of the tension belt 125. Put differently, the user may pull on the belt adjuster end 130 to tighten the tension belt 125. As should be appreciated, the lever adjuster 110 is configured to automatically lock on to the tension belt 125 to retain the tension belt 125 at the adjusted length. To adjust the length of the tension belt 125 the user generally needs to release a lever and/or button to allow free movement of the tension belt 125 and/or belt adjuster end 130 through the lever adjuster 110.

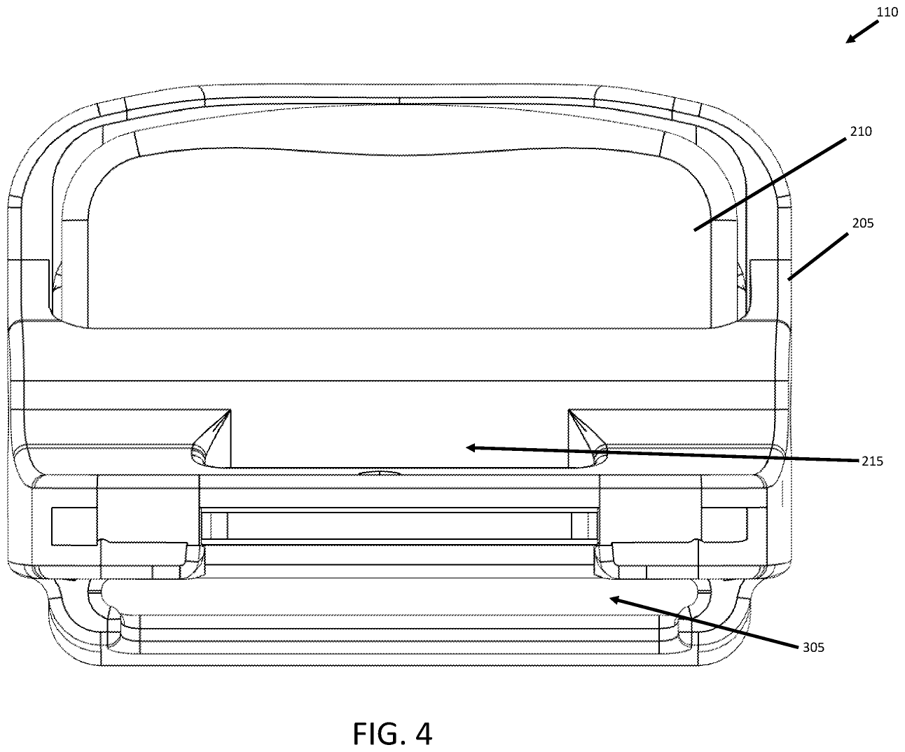

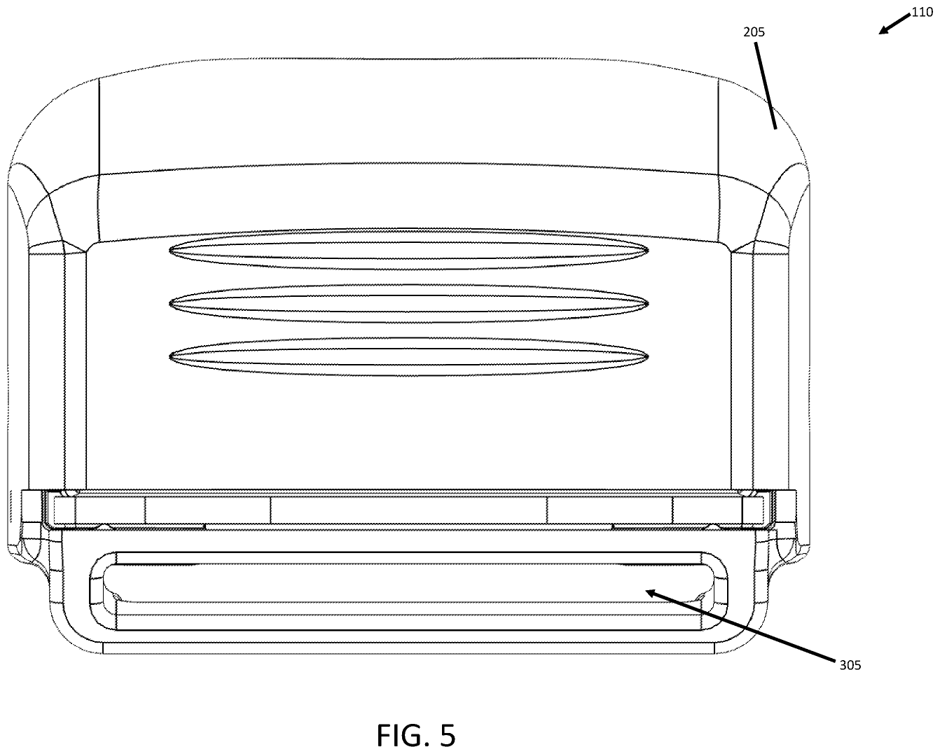

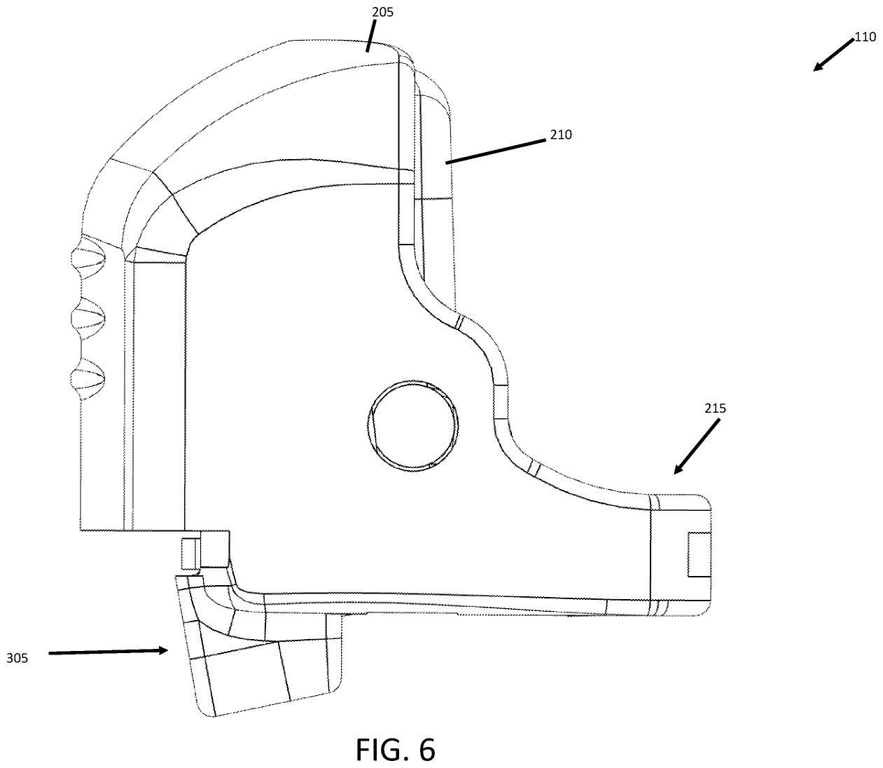

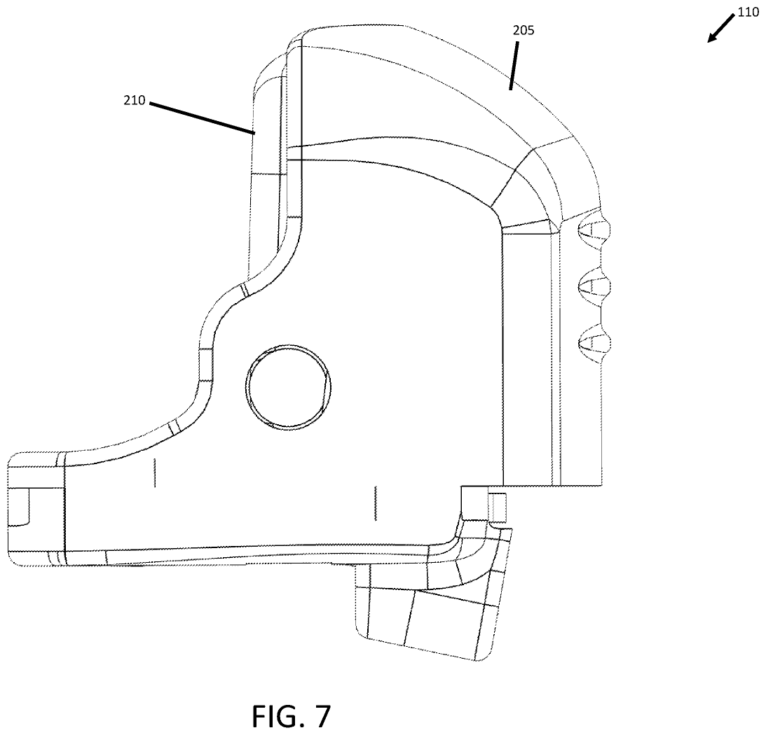

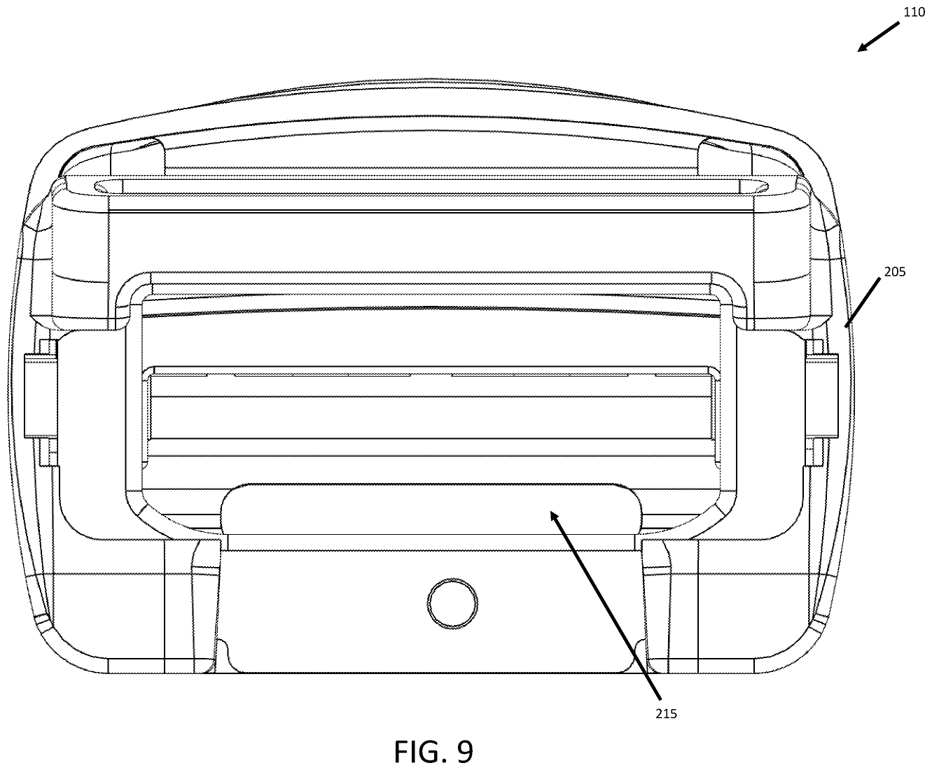

Turning to FIGS. 2, 3, 4, 5, 6, 7, 8, and 9, a plurality of different views of the lever adjuster 110 are shown. The lever adjuster 110 is shown to further include a cover 205 configured to secure components of the lever adjuster 110. Within the cover 205 is a trigger 210. The trigger 210 is configured to act as a lever. For example, the user actuates the trigger 210 by applying force to the trigger 210 in order to release the tension belt 125. The cover 205 is generally made from plastic and/or another polymeric material. However, the cover 205 may also be made from metal and/or a metallic material. The trigger 210 is generally made from the same material as the cover 205. In other examples, the cover 205 and the trigger 210 are made from different materials.

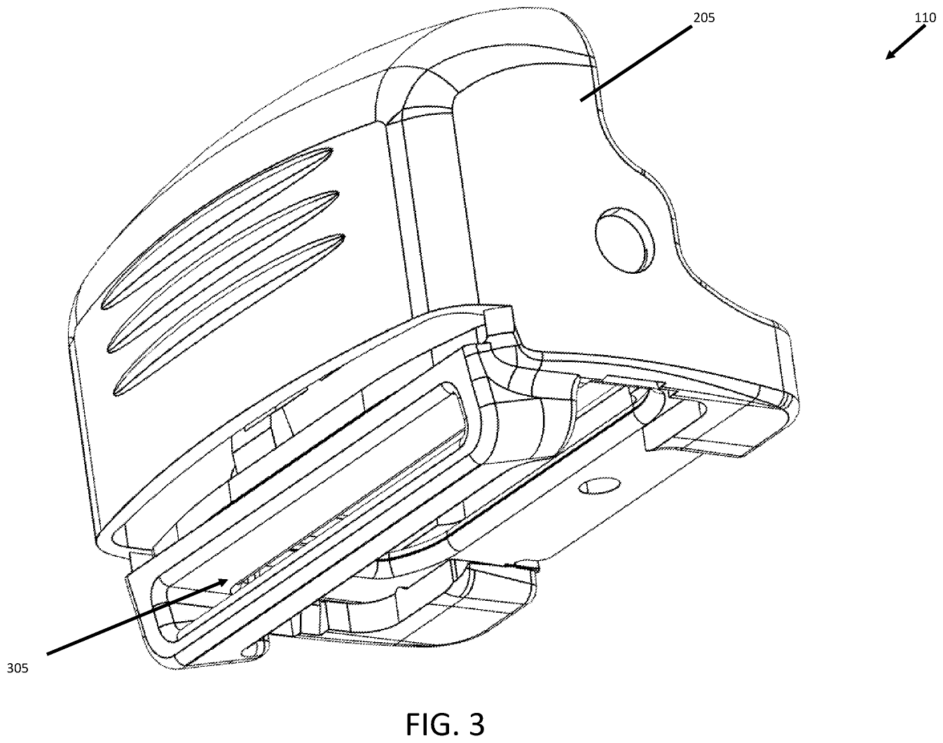

The lever adjuster 110 further includes a belt mount 215 and a belt opening 305 (shown in FIG. 3). The belt mount 215 is configured to serve as a mounting location for the fixed belt 120. In one example, the fixed belt 120 is wrapped around the belt mount 215 and secured via stiches. In another example, the fixed belt 120 is secured to the belt mount 215 via a clamp and/or other fastener. The belt opening 305 is configured to receive an end of the belt 115. In one example, the belt opening 305 is configured to receive the belt adjuster end 130 of the tension belt 125

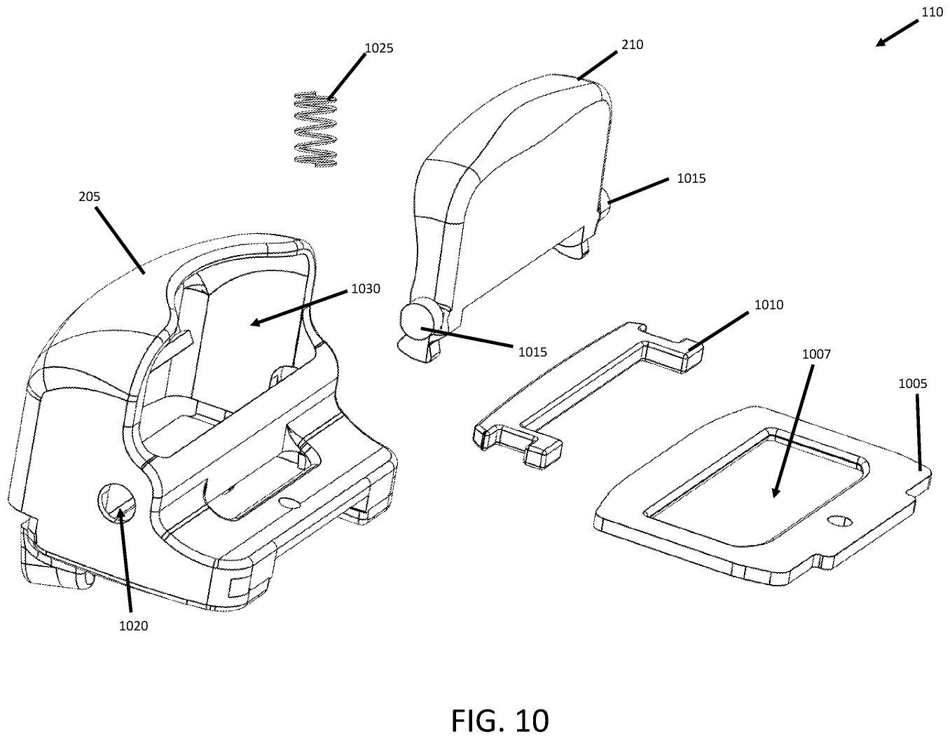

FIG. 10 shows an exploded view of the lever adjuster 110. The lever adjuster 110 is shown to further include a frame 1005 configured to support and provide structure to the lever adjuster 110. The frame 1005 further includes a window 1007 configured to work with a belt bar 1010 and/or cross bar to secure the tension belt 125. As will be described later, the belt bar 1010 is configured to rest on the frame 1005 and actuate via the trigger 210 to release/secure the tension belt 125.

The trigger 210 is shown to further include a pair of pivot pins 1015. The pivot pins 1015 are configured to fit inside of a corresponding pair of sockets 1020 in the cover 205. The trigger 210 is configured to mount within the cover 205 via the pivot pins 1015 via a friction and/or snap fit. a spring 1025 is configured to rest between the trigger 210 and a front of the cover 205. The spring 1025 is configured to bias the trigger 210 into a preset position where the tension belt 125 is locked into position. In one example, the trigger 210 is held within a shroud 1030 of the cover 205. In one example, the shroud 1030 is configured to surround and/or cover a majority of the trigger 210. As should be appreciated, the shroud 1030 is designed to prevent accidental actuation of the trigger 210. In one example, the shroud 1030 is generally flush with the trigger 210. In another example, the trigger 210 is recessed within the shroud 1030. In another form, the trigger 210 needs to be pressed beyond a face of the shroud 1030 in order to release the tension belt 125. As should be appreciated, the spring 1025 is further configured to prevent accidental actuation of the trigger 210 by biasing the trigger 210 away from an interior of the shroud 1030.

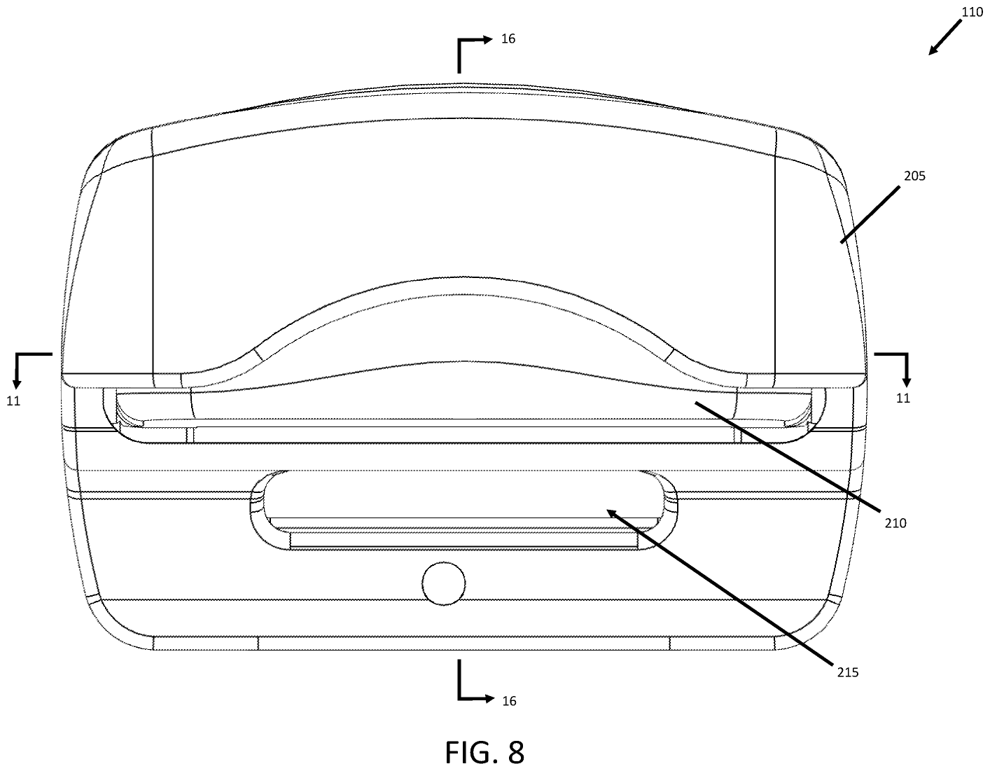

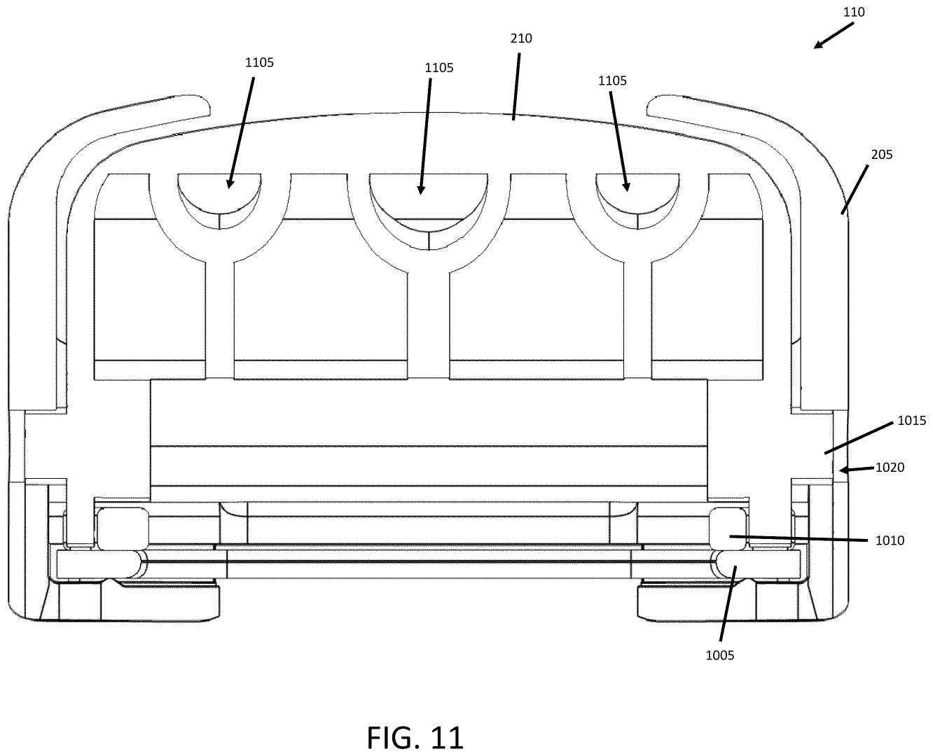

A cross-sectional view of the lever adjuster 110 as taken along line 11-11 in FIG. 8 is shown in FIG. 11. FIG. 11 arguably shows a better example of the interaction between the pivot pins 1015 and the sockets 1020. For example, the pivot pins 1015 are shown to be received within the sockets 1020. Furthermore, the belt bar 1010 is shown resting on the frame 1005 as described previously. One or more spring apertures 1105 are also shown within the trigger 210. The spring apertures 1105 are configured to receive the springs 1025 described previously. In one example, the trigger 210 includes a single spring aperture 1105 with a single spring 1025. In another example, the trigger 210 includes more than one spring aperture 1105 and more than one spring 1025. For example, the trigger 210 includes three (3) spring apertures 1105 corresponding to three (3) springs 1025.

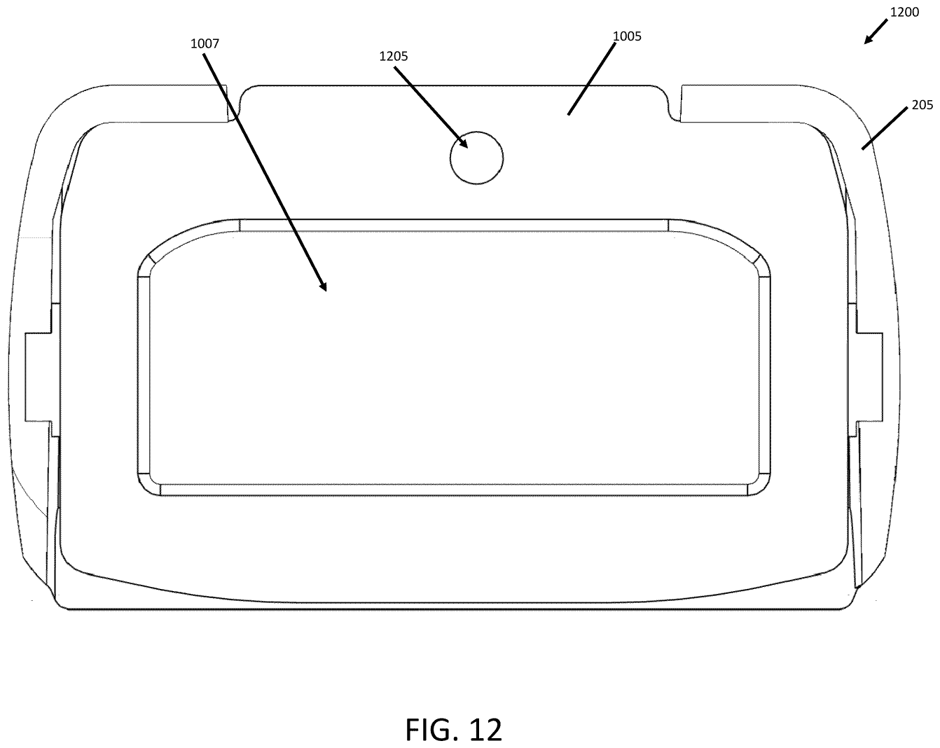

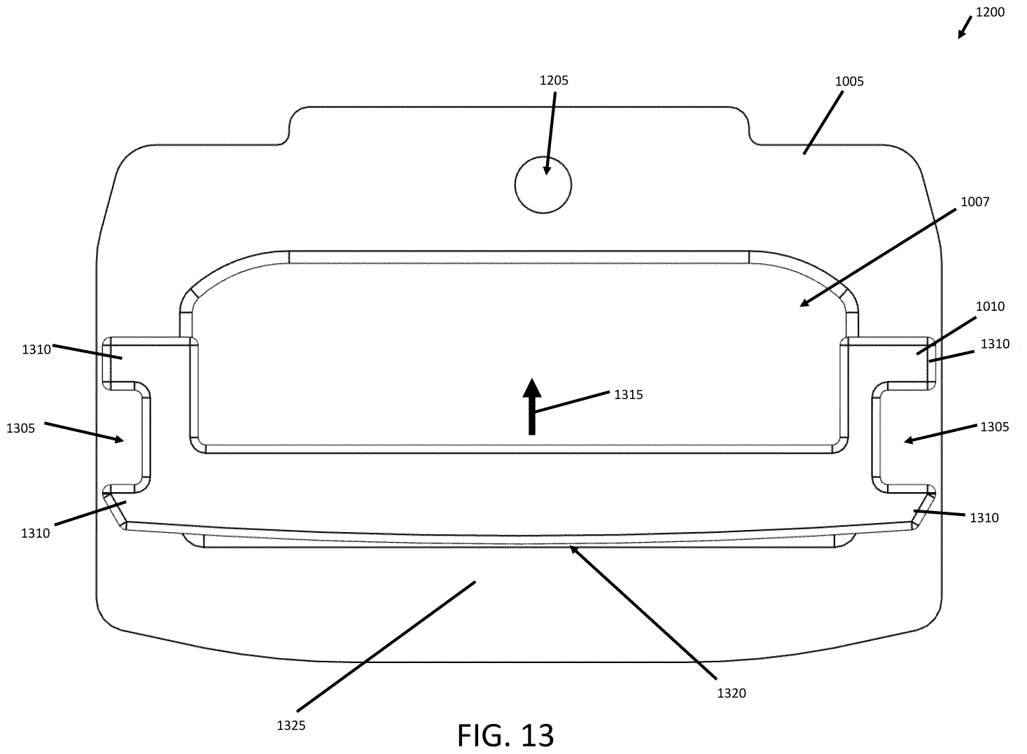

FIGS. 12 and 13 show one example of a retention assembly 1200. The retention assembly 1200 includes the frame 1005 and the belt bar 1010. The frame 1005 is secured within the cover 205 via a fastener through an aperture 1205. The aperture 1205 is configured to receive a rivet. In other examples, the aperture 1205 is configured to receive other fasteners, such as bolts, screws, nails, adhesive, and/or other fasteners. Resting on the frame 1005 is the belt bar 1010. The belt bar 1010 and the frame 1005 are generally made from stamped metal. In other examples, the belt bar 1010 and the frame 1005 are made from other materials, such as plastic and/or other metals. Generally, the metals used for the frame 1005 and the belt bar 1010 are designed to have a low friction coefficient such that the belt bar 1010 is able to slide freely over the frame 1005 with minimal force.

The belt bar 1010 is shown to include a notch 1305 defined by one or more posts 1310. Generally, the belt bar 1010 has two (2) ends each including a notch 1305 and a pair of posts 1310 forming the notch 1305. The belt bar 1010 is configured to slide on the frame 1005 as shown by arrow 1315. As the belt bar 1010 slides as shown by arrow 1315 a gap 1320 expands. As should be appreciated, the tension belt 125 is generally squeezed and/or compressed between the belt bar 1010 and a first end 1325 of the frame 1005. As the belt bar 1010 moves as shown by arrow 1315 the gap 1320 is made larger, thus releasing the tension belt 125.

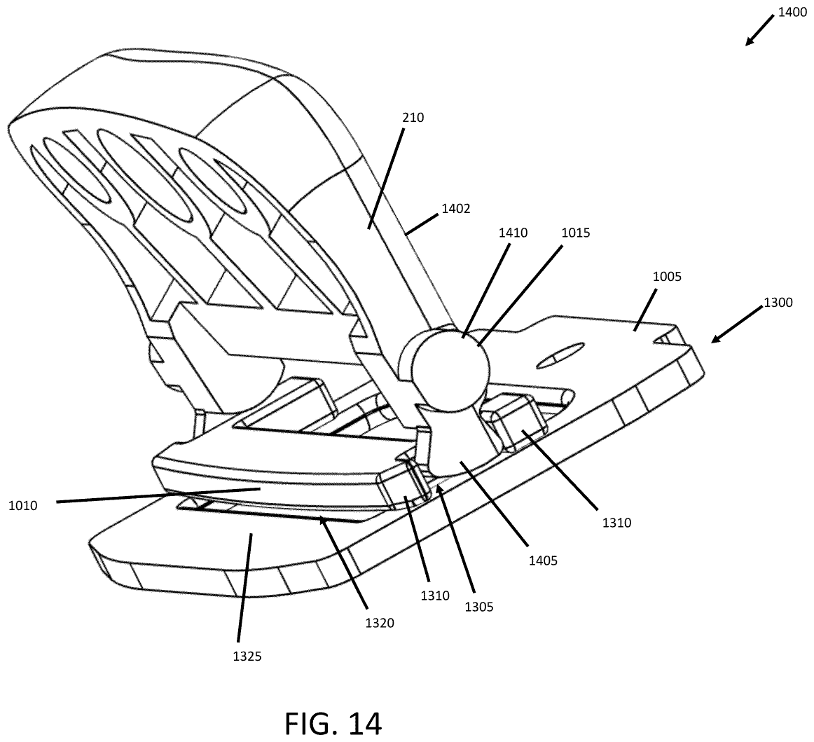

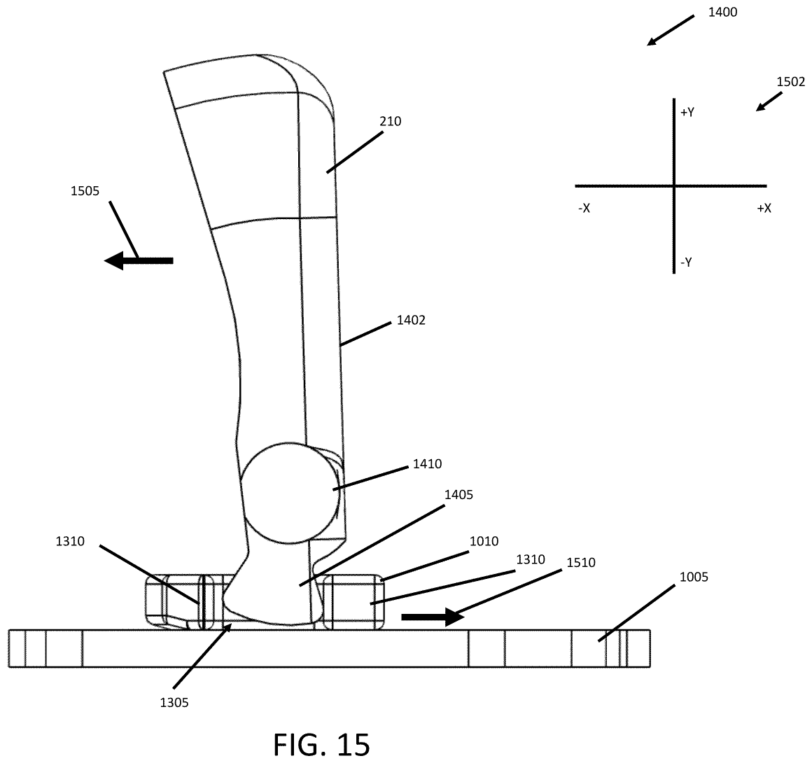

FIGS. 14 and 15 shows an example of an adjustment assembly 1400. The adjustment assembly 1400 includes the components of the retention assembly 1200 discussed previously, with the addition of the trigger 210. As can be seen, the trigger 210 is configured to function as a lever 1402. Specifically, the trigger 210 is configured to function as a class one lever. The trigger 210 includes a bar engagement portion 1405 configured to nest within the notch 1305 of the belt bar 1010. The lever 1402 is configured to pivot about a fulcrum 1410 defined by the pivot pins 1015. As should be appreciated, lever 1402 is designed to reduce the amount of force needed to release the tension belt 125. For example, by using a lever system, the lever adjuster 110 is able to reduce the amount of force required by approximately 30%.

In FIG. 15, a coordinate system 1502 is shown to better understand the directions of the force vectors. As shown by arrow 1505, to release the tension belt 125, force is applied to the trigger 210 in the −X direction. Correspondingly, force is applied as shown by arrow 1510 in the +X direction to the belt bar 1010. As should be appreciated, the force in the +X direction actuates the belt bar 1010 and releases the tension belt 125. Furthermore, it should be noted that the direction of the force vector on the trigger 210 and the force vector on the belt bar 1010 are parallel to one another. More specifically, the direction of the force vector on the trigger 210 and the belt bar 1010 are parallel to one another and in opposite directions. Thus, force applied to the trigger 210 in the −X direction equals force applied to the belt bar 1010 in the +X direction. As the lever arm of the bar engagement portion 1405 is shorter than the lever arm above the fulcrum 1410, the force is multiplied due to the equation F2=(F1*L1)/L2 where F2 equals force at the bar engagement portion 1405, F1 equals force at the trigger 210, L1 equals lever arm above the fulcrum 1410, and where L2 equals lever arm of the bar engagement portion 1405

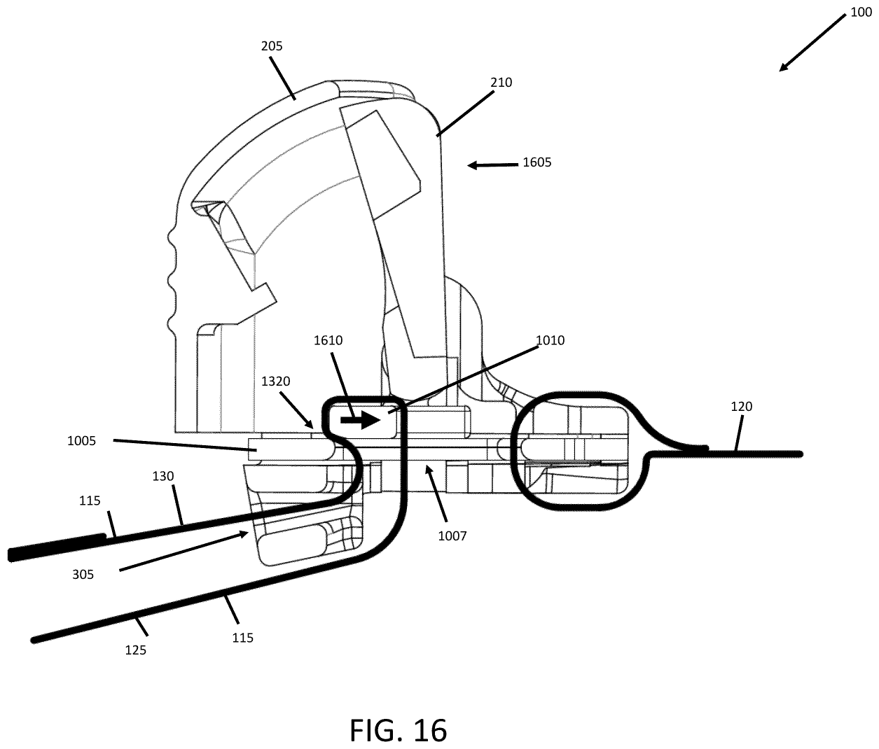

A cross-sectional view of the lever adjuster 110 as taken along line 16-16 in FIG. 8 is shown in FIG. 16. FIG. 16 shows an example of how the tension belt 125 is routed through the lever adjuster 110. For example, the belt adjuster end 130 of the tension belt 125 is routed through the belt opening 305 and then up through the window 1007 into the lever adjuster 110. Once in the lever adjuster 110, the belt adjuster end 130 is wrapped around the belt bar 1010 and through the gap 1320. The belt adjuster end 130 is then passed back through the belt opening 305. As has been mentioned previously, the belt 115 is squeezed and/or compressed between the frame 1005 and the belt bar 1010 to prevent movement of the belt 115. However, applying force as shown by arrow 1605 to the trigger 210 actuates the belt bar 1010 as shown by arrow 1610, thus enlarging the gap 1320 and enabling adjustment of the tension belt 125 via the belt adjuster end 130.

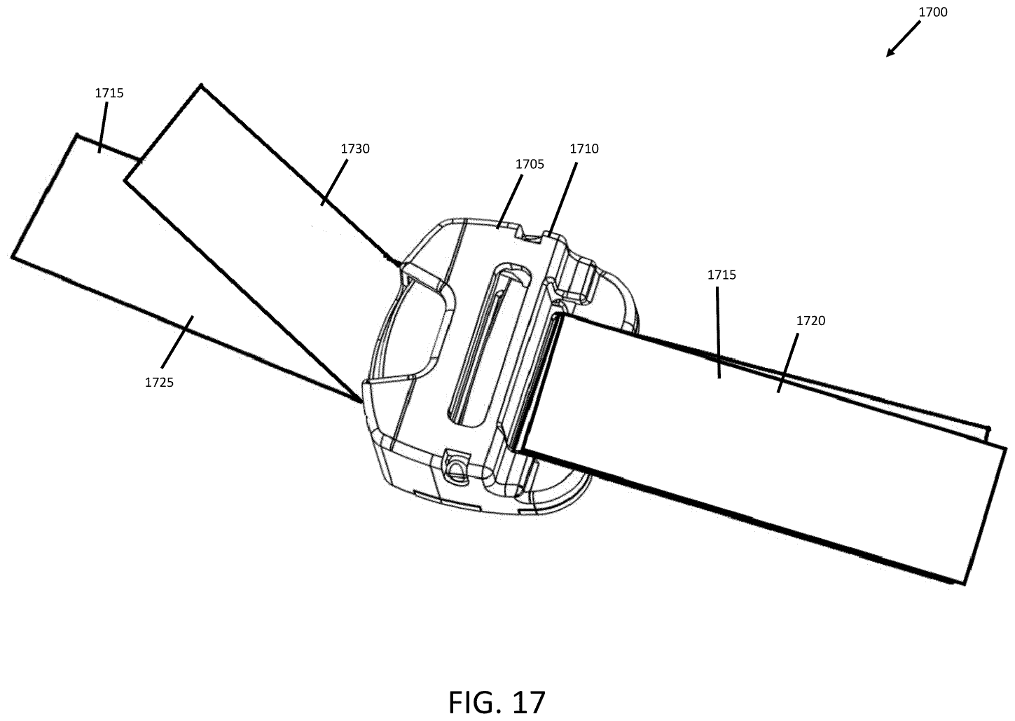

FIG. 17 shows another embodiment of a belt system 1700. As should be appreciated, the belt system 1700 includes many of the same and/or similar components as the belt system 100 described previously. The belt system 1700 includes a belt adjuster 1705. In one example, the belt adjuster 1705 is in the form of a lever adjuster 1710. The lever adjuster 1710 is configured to reduce the amount of force required to release a belt 1715. The lever adjuster 1710 is generally used an adjustment mechanism for a child safety seat. In one example, the lever adjuster 1710 is used to adjusted a length of one or more belts 1715 to properly secure the child safety seat. As should be appreciated, some belt adjusters require large amounts of force to release the belt when the belt is under tension. Utilizing the lever adjuster 1710, requires less force to release the belt 1715.

The lever adjuster 1710 generally connects to one or more belts 1715. In one example, the belts 1715 are in the form of tubular webbing. In another example, the belts 1715 are in the form of rope, chains, cables, fabric, and/or other material. For example, the lever adjuster 1710 has a fixed connection to a fixed belt 1720. In one example, the fixed belt 1720 is configured to extend between the child safety seat and the lever adjuster 1710. Generally, the fixed belt 1720 has a preset length and is not adjustable. However, in other examples, the fixed belt 1720 has an adjustable length. The lever adjuster 1710 is further removably connected to a tension belt 1725. In one example, the tension belt 1725 is adjustable via a belt adjuster end 1730. For example, a user may pull on the belt adjuster end 1730 to reduce the length of the tension belt 1725. Put differently, the user may pull on the belt adjuster end 1730 to tighten the tension belt 1725. As should be appreciated, the lever adjuster 1710 is configured to automatically lock on to the tension belt 1725 to retain the tension belt 1725 at the adjusted length. To adjust the length of the the user generally needs to release a lever and/or button to allow free movement of the tension belt 1725 and/or belt adjuster end 1730 through the lever adjuster 1710.

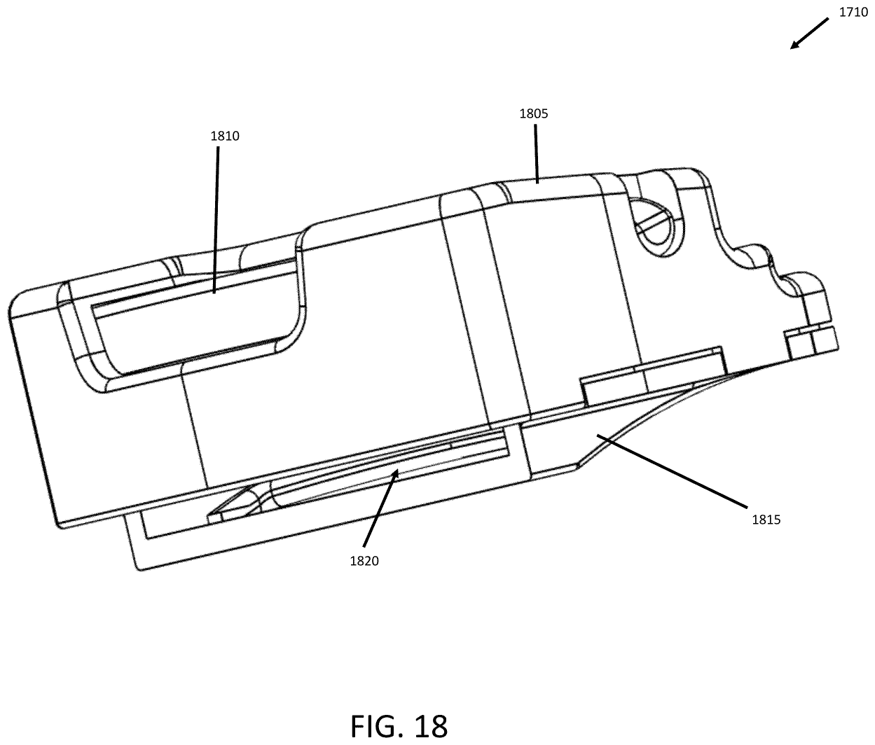

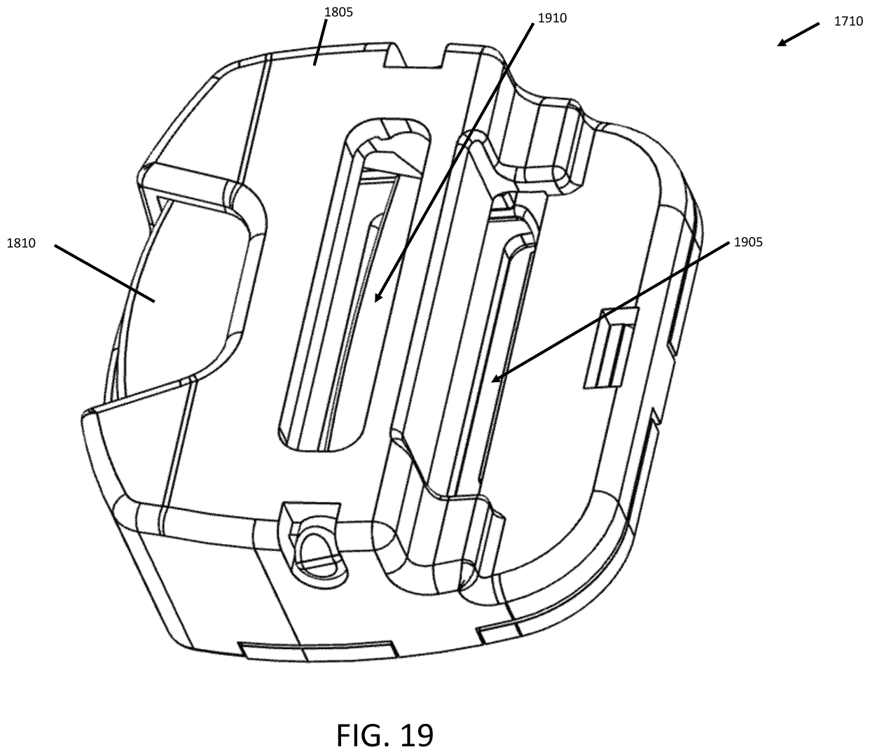

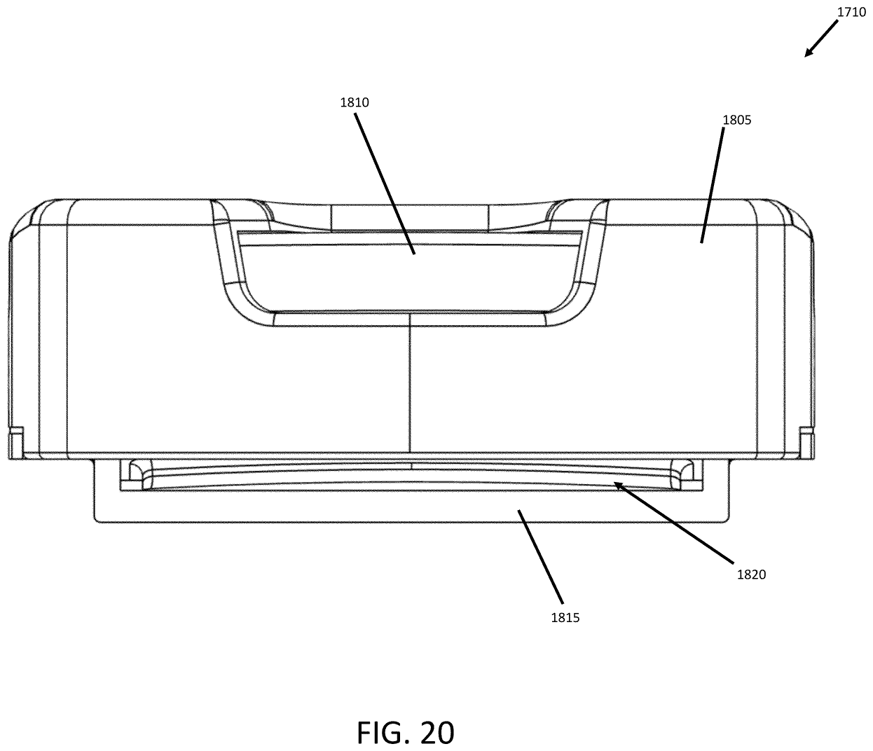

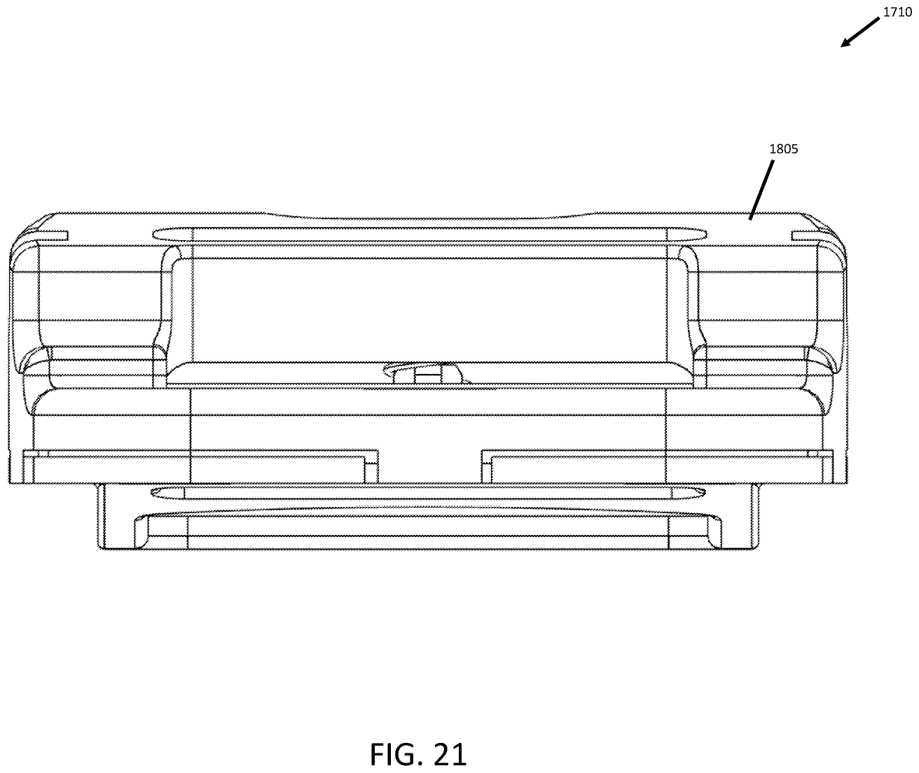

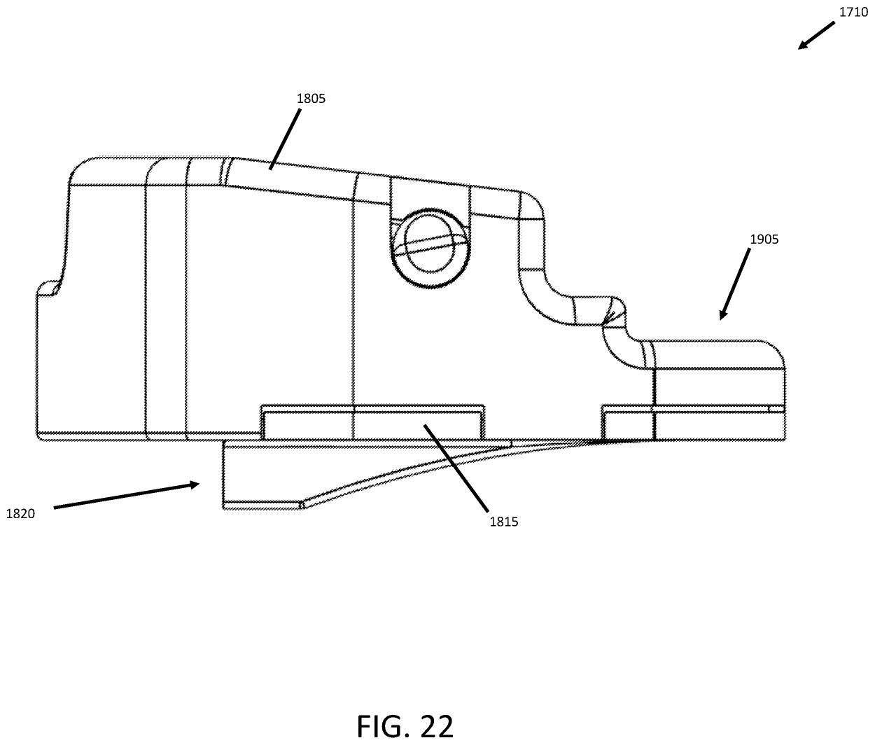

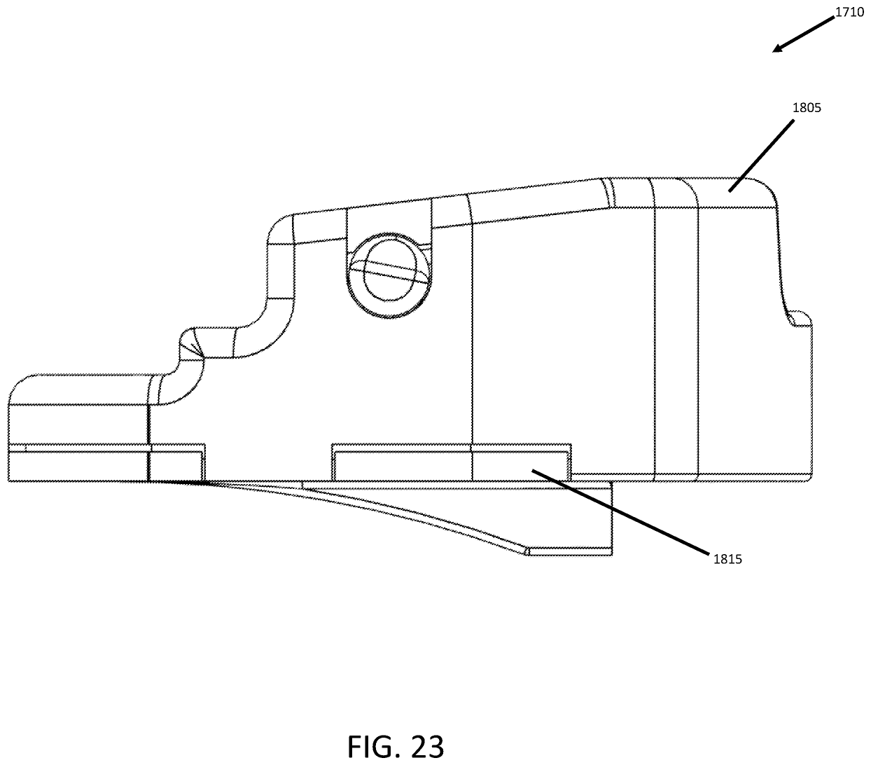

Turning to FIGS. 18, 19, 20, 21, 22, 23, 24, and 25, a plurality of different views of the lever adjuster 1710 are shown. The lever adjuster 1710 is shown to further include a cover 1805 configured to secure components of the lever adjuster 1710. Within the cover 1805 is a trigger 1810. The trigger 1810 is configured to act as a lever. For example, the user actuates the trigger 1810 by applying force to the trigger 1810 in order to release the tension belt 1725. The lever adjuster 1710 further includes a base 1815. The base 1815 is configured to attach to the cover 1805 to secure components of the belt adjuster 1705. The base 1815 defines a belt opening 1820. The belt opening 1820 is configured to receive an end of the belt 1715. In one example, the belt opening 1820 is configured to receive the belt adjuster end 1730 of the tension belt 1725. The cover 1805 and the belt opening 1820 are generally made from plastic and/or another polymeric material. However, the cover 1805 and belt opening 1820 may also be made from metal and/or a metallic material. The trigger 1810 is generally made from the same material as the cover 1805 and the belt opening 1820. In other examples, the cover 1805, belt opening 1820, and the trigger 1810 are made from different materials.

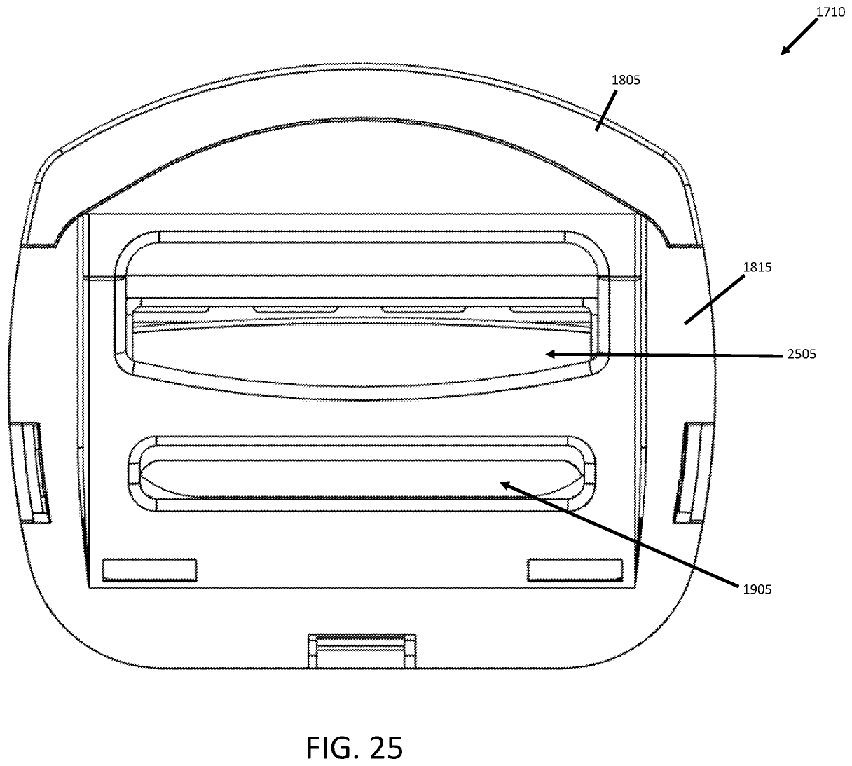

The lever adjuster 1710 further includes a belt mount 1905 and a sight window 1910. The belt mount 1905 is configured to serve as a mounting location for the fixed belt 1720. In one example, the fixed belt 1720 is wrapped around the belt mount 1905 and secured via stiches. In another example, the fixed belt 1720 is secured to the belt mount 1905 via a clamp and/or other fastener. The sight window 1910 is configured to enable a user to visually confirm proper alignment of the tension belt 1725 within the lever adjuster 1710. Additionally, the sight window 1910 enables a user to adjust/straighten the tension belt 1725 within the lever adjuster 1710 to optimize performance. As best shown in FIG. 25, the lever adjuster 1710 includes a secondary belt opening 2505 configured to receive an end of the belt 1715.

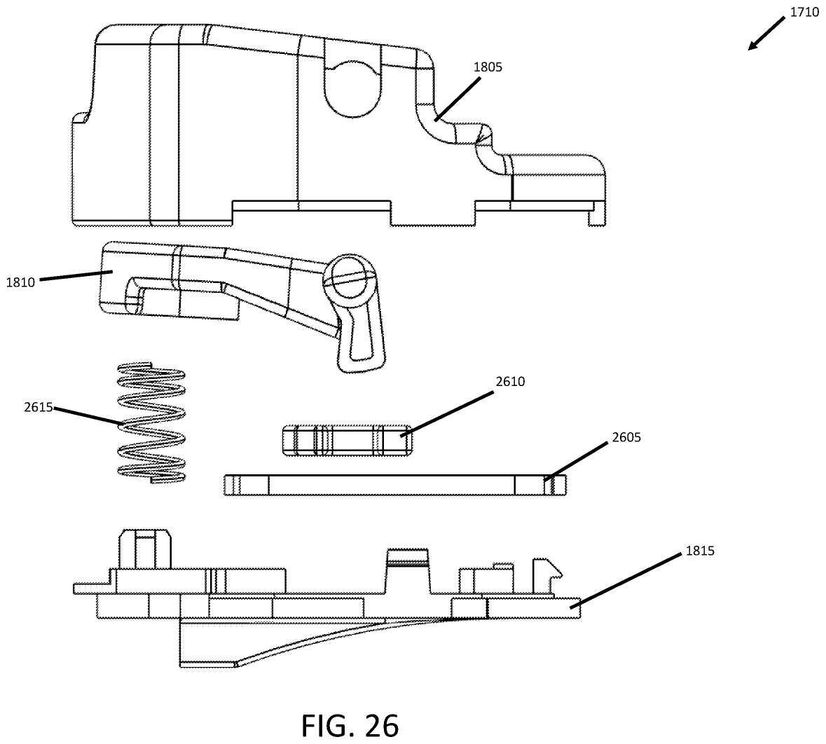

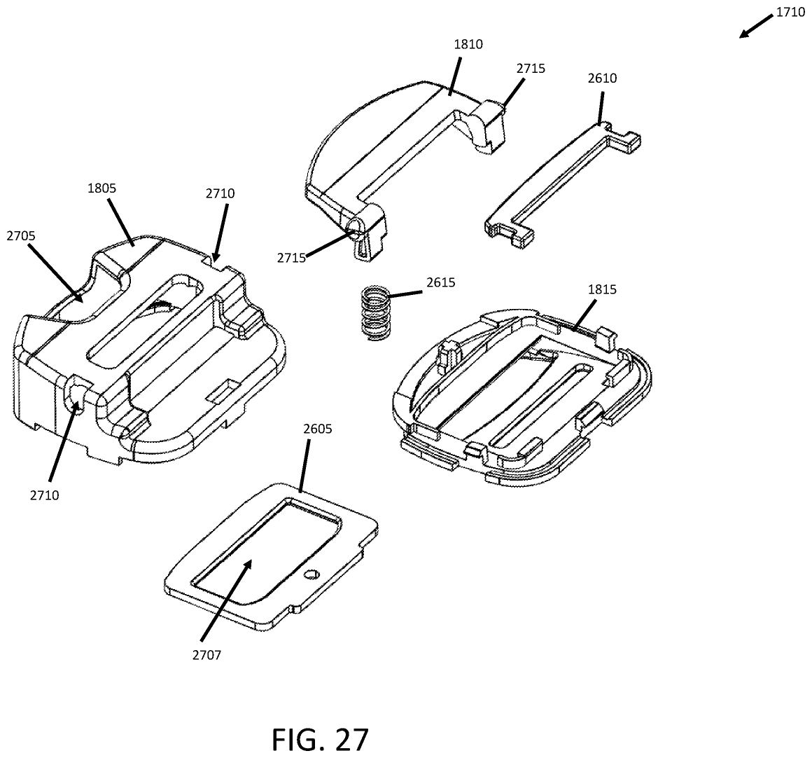

FIGS. 26 and 27 show exploded views of the lever adjuster 1710. The lever adjuster 1710 is shown to further include a frame 2605 configured to support and provide structure to the lever adjuster 1710. The frame 2605 further includes a window 2707 configured to work with a belt bar 2610 and/or cross bar to secure the tension belt 1725. As will be described later, the belt bar 2610 is configured to rest on the frame 2605 and actuate via the trigger 1810 to release/secure the tension belt 1725.

The trigger 1810 is shown to further include a pair of pivot pins 2715. The pivot pins 2715 are configured to fit inside of a corresponding pair of sockets 2710 in the cover 1805. The trigger 1810 is configured to mount within the cover 1805 via the sockets 2710 via a friction and/or snap fit. In one example, the pivot pins 2715 include a beveled edge. The beveled edge is configured to prevent catching and/or potential injuries to a user and/or the belt 1715. a spring 2615 is configured to bias the trigger 1810 into position. The spring 2615 is configured to bias the trigger 1810 into a preset position where the tension belt 1725 is locked into position. In one example, the trigger 1810 is held within a shroud 2705 of the cover 1805. In one example, the shroud 2705 is configured to surround and/or cover a majority of the trigger 1810. As should be appreciated, the shroud 2705 is designed to prevent accidental actuation of the trigger 1810. In one example, the shroud 2705 is generally flush with the trigger 1810. In another example, the trigger 1810 is recessed within the shroud 2705. In another form, the trigger 1810 needs to be pressed beyond a face of the shroud 2705 in order to release the tension belt 1725. As should be appreciated, the spring 2615 is further configured to prevent accidental actuation of the trigger 1810 by biasing the trigger 1810 away from an interior of the shroud 2705.

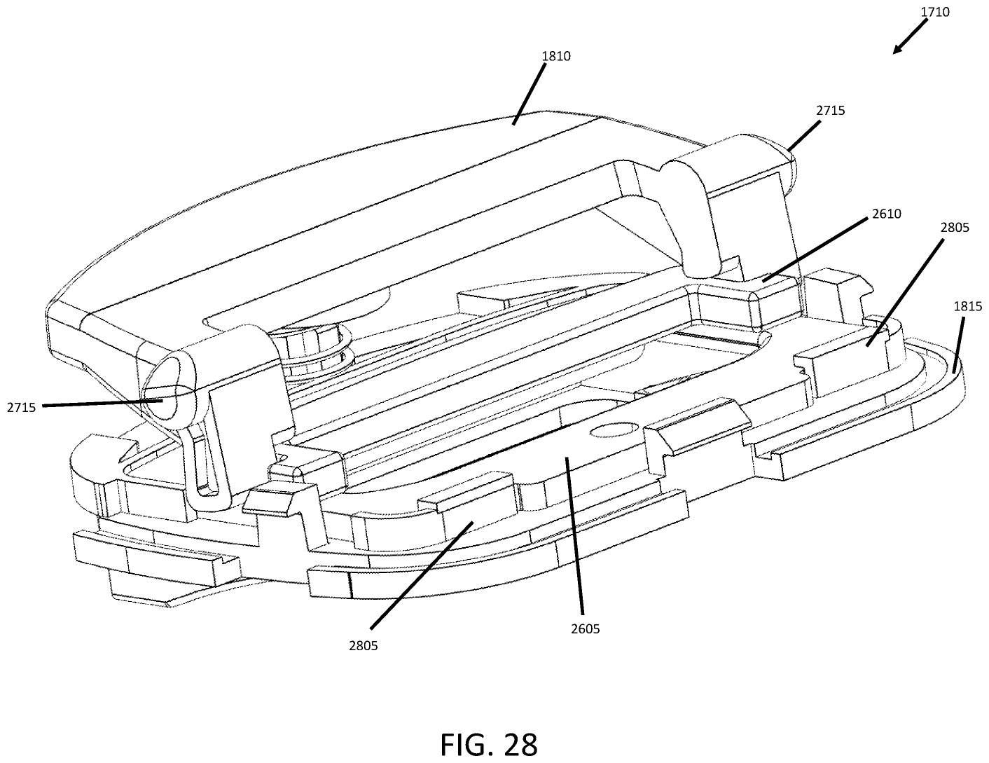

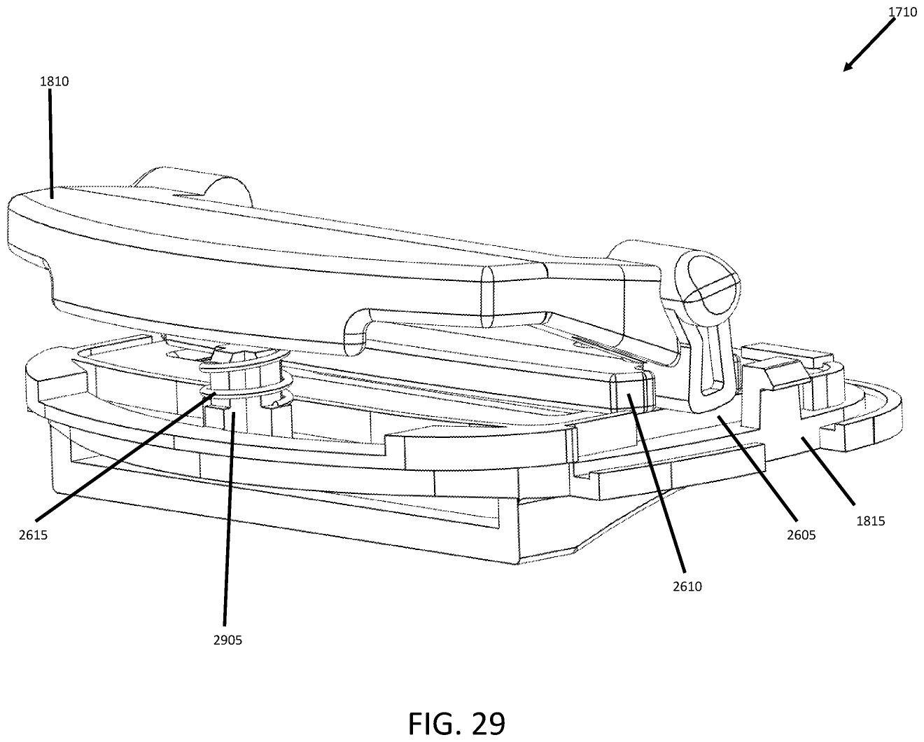

FIGS. 28 and 29 show examples of the lever adjuster 1710 without the cover 1805. As can best be seen in FIG. 28, the frame 2605 is held onto the base 1815 via one or more prongs 2805. The prongs 2805 are generally configured to retain the frame 2605 via a snap fit. For example, the frame 2605 may be replaced and/or inserted by removing the base 1815 from the cover 1805 and applying pressure to the frame 2605 to snap the frame 2605 into the base 1815. As can best be seen in FIG. 29, the spring 2615 is held in position via a mounting post 2905. The mounting post 2905 is configured to receive and support the spring 2615. The spring 2615 is generally held transverse and/or perpendicular to the trigger 1810 to bias the trigger 1810 into position. In one example, the lever adjuster 1710 includes a single mounting post 2905 with a single spring 2615. In other examples, the lever adjuster 1710 includes two or more mounting posts 2905 configured to receive two or more springs 2615. As should be appreciated, a greater number of springs 2615 increases the biasing force on the trigger 1810.

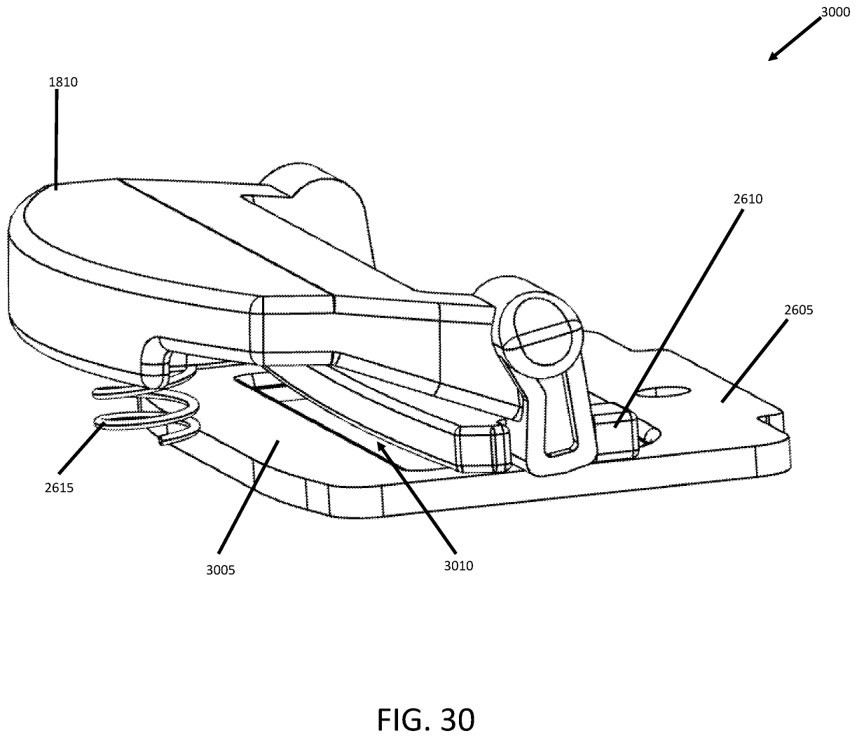

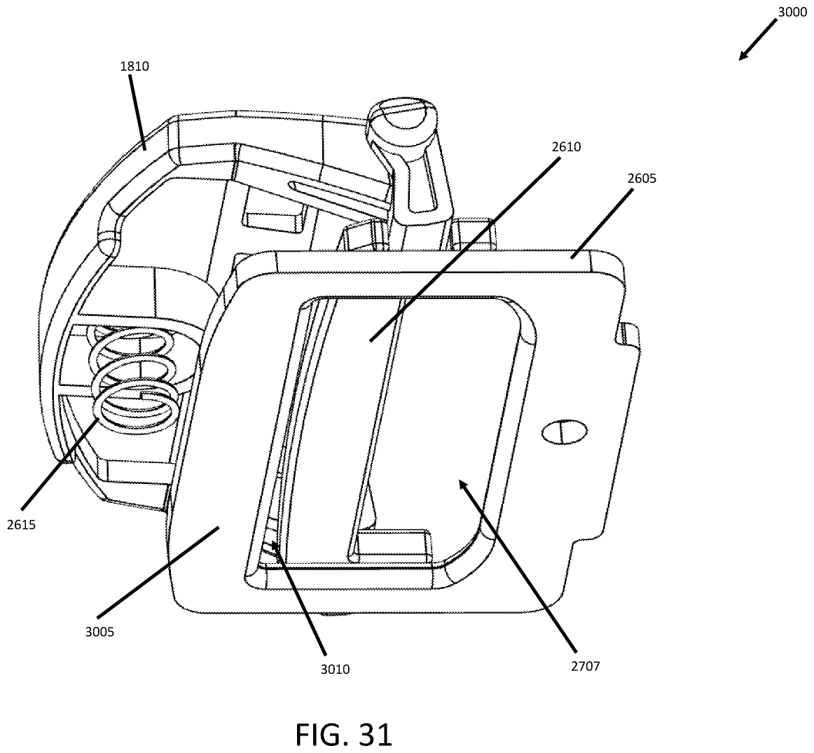

FIGS. 30, 31, and 32 show examples of an adjustment assembly 3000. The adjustment assembly 3000 includes the frame 2605, the belt bar 2610, and the trigger 1810. As can best be seen in FIG. 30, a first end 3005 of the frame 2605 and the belt bar 2610 form a gap 3010. The belt bar 2610 is configured to slide on the frame 2605. As the belt bar 2610 slides along the frame 2605 the gap 3010 expands. As should be appreciated, the tension belt 1725 is generally squeezed and/or compressed between the belt bar 2610 and the first end 3005 of the gap 3010. As the belt bar 2610 moves the gap 3010 is made larger, thus releasing the tension belt 1725.

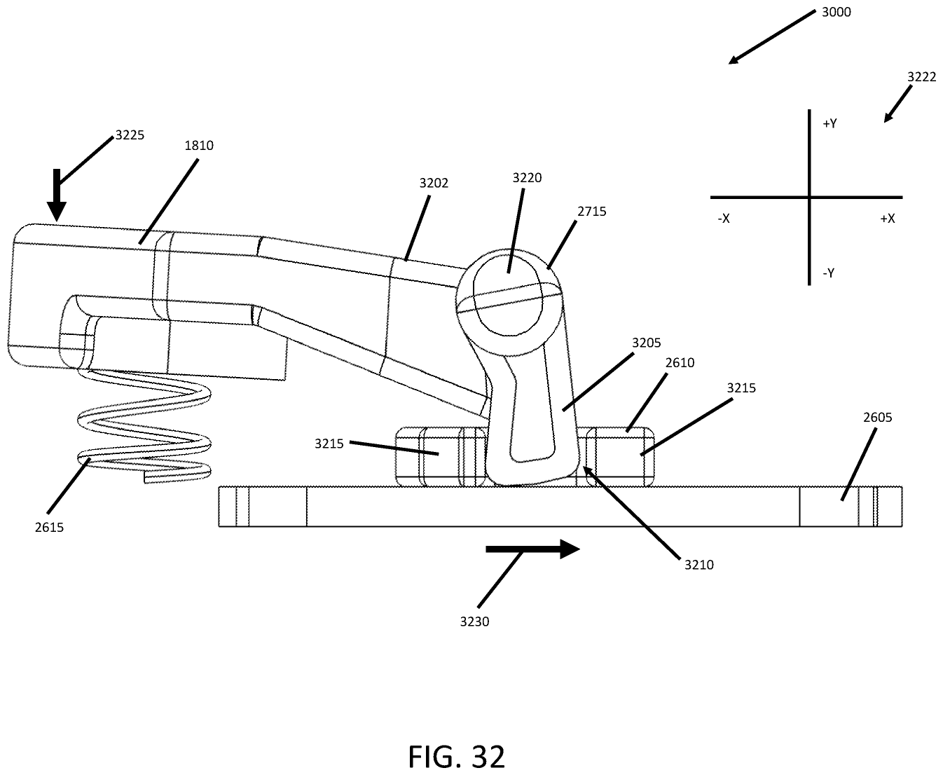

As best shown in FIG. 32, the trigger 1810 is configured to function as a lever 3202. Specifically, the trigger 1810 is configured to function as a class one lever. The trigger 1810 includes a notch engagement portion 3205 configured to nest within a notch 3210 of the belt bar 2610. The notch 3210 is formed by a pair of posts 3215 extending from the belt bar 2610. The lever 3202 is configured to pivot about a fulcrum 3220 defined by the pivot pins 2715. As should be appreciated, lever 3202 is designed to reduce the amount of force needed to release the tension belt 1725. For example, by using a lever system, the lever adjuster 1710 is able to reduce the amount of force required by approximately 30%.

In FIG. 32, a coordinate system 3222 is shown to better understand the directions of the force vectors. As shown by arrow 3225, to release the tension belt 1725, force is applied to the trigger 1810 in the −Y direction. Correspondingly, force is applied as shown by arrow 3230 in the +X direction to the belt bar 2610. As should be appreciated, the force in the +X direction actuates the belt bar 2610 and releases the tension belt 1725. Furthermore, it should be noted that the direction of the force vector on the trigger 1810 and the force vector on the belt bar 2610 are perpendicular and/or transverse to one another. Thus, force applied to the trigger 1810 in the −Y direction equals force applied to the belt bar 2610 in the +X direction. As the lever arm of the notch engagement portion 3205 is shorter than the lever arm of the trigger 1810, the force is multiplied due to the equation F2=(F1*L1)/L2 where F2 equals force at the notch engagement portion 3205, F1 equals force at the trigger 1810, L1 equals lever arm of the trigger 1810, and where L2 equals lever arm of the notch engagement portion 3205. As should be appreciated, the force vector on the trigger 1810 is directed in the direction of gravity. Thus, the amount of force required to actuate the belt bar 2610 is further reduced.

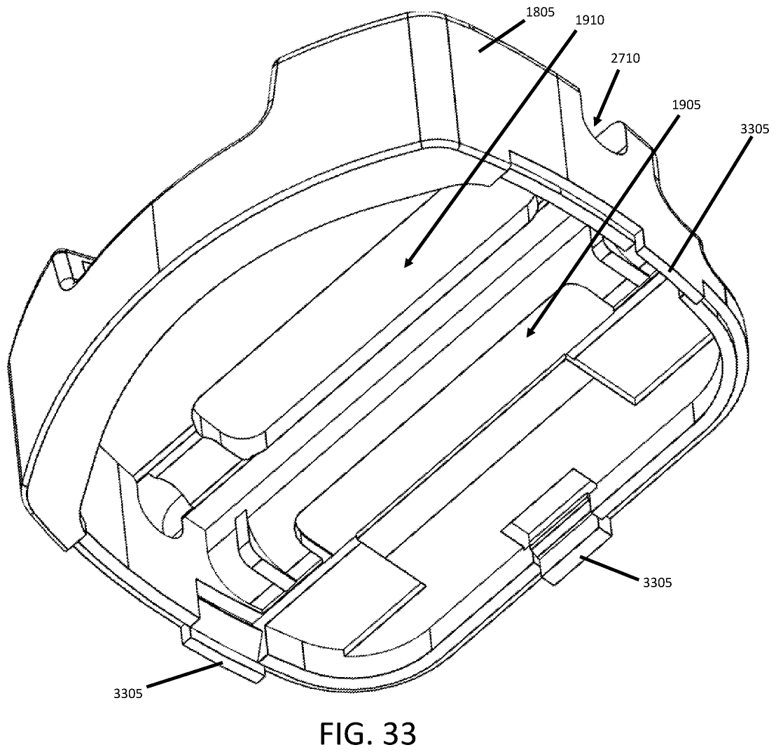

FIG. 33 shows an example of the cover 1805. The cover 1805 is shown to include one or more prongs 3305. The prongs 3305 are configured to interact with the base 1815 to secure the base 1815 and the cover 1805 via a friction and/or snap fit. As should be appreciated, the component of the lever adjuster 1710 discussed are generally held within a cavity between the cover 1805 and the base 1815. Put differently, the components of the lever adjuster 1710 are generally sandwiched between the cover 1805 and the base 1815.

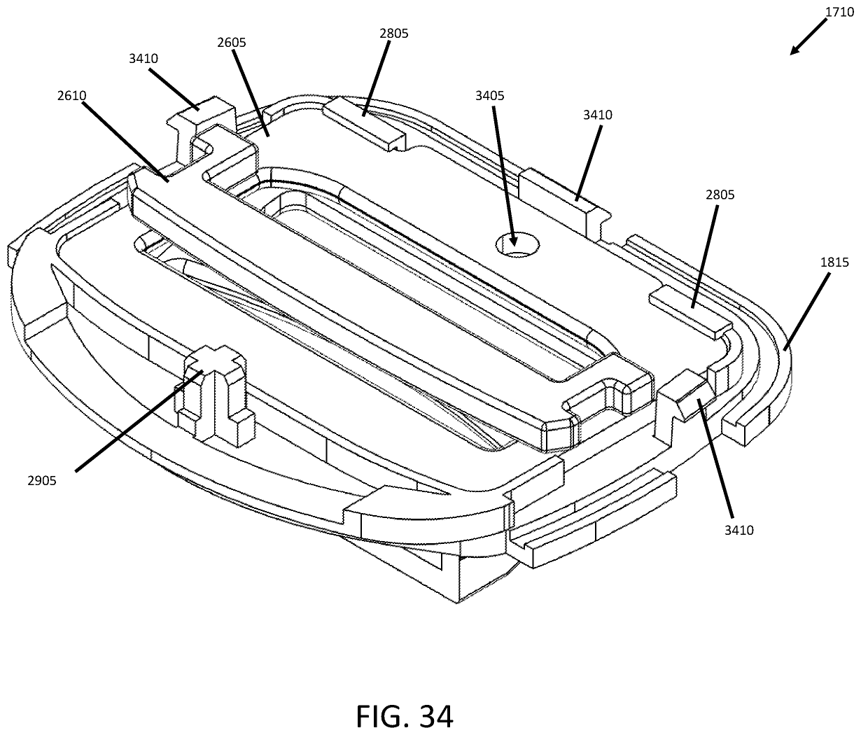

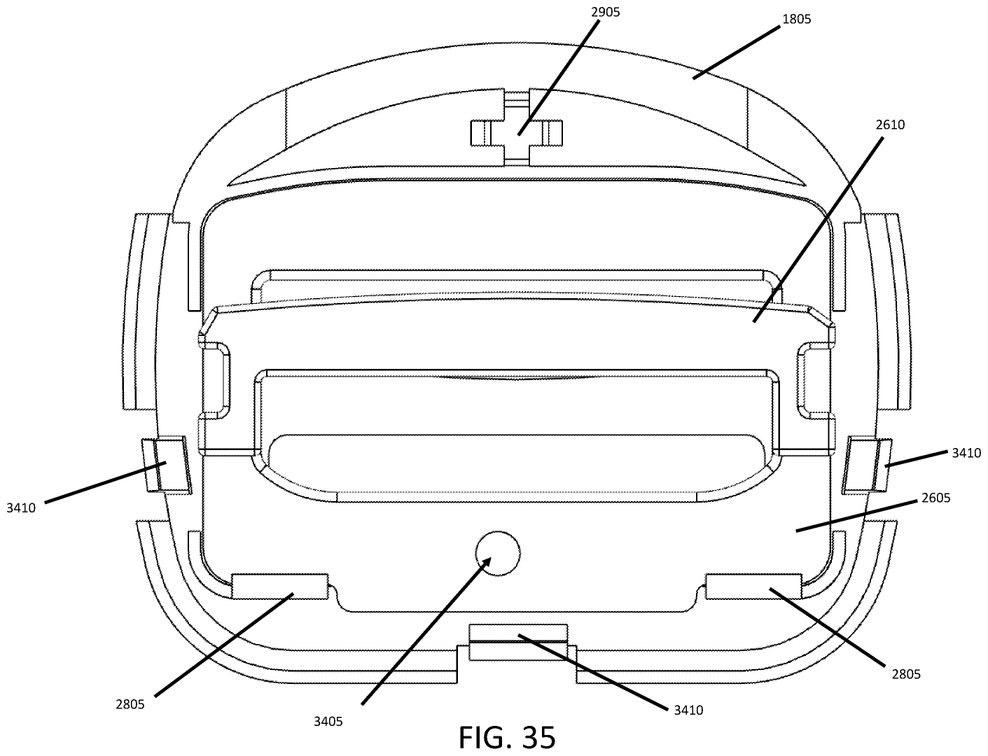

FIGS. 34 and 35 show examples of the lever adjuster 1710 without the cover 1805 and the trigger 1810. The frame 2605 is shown to include an aperture 3405. The aperture 3405 is configured to receive a fastener to secure the frame 2605 within the base 1815. The fastener in one form is a rivet. In other examples, the fastener is a bolt, screw, nail, adhesive, and/or other fastener. The base 1815 is further shown to include a plurality of prongs 3410. The prongs 3410 are configured to interact with the prongs 3305 of the cover 1805 as discussed previously. The prongs 3410 are generally configured to attach the cover 1805 and the base 1815 via a friction and/or snap fit.

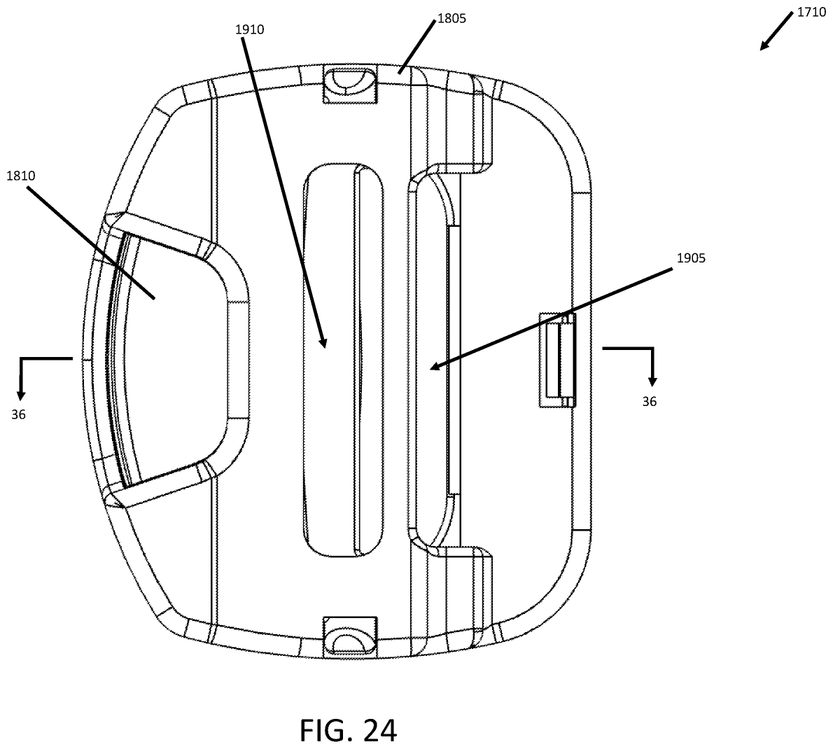

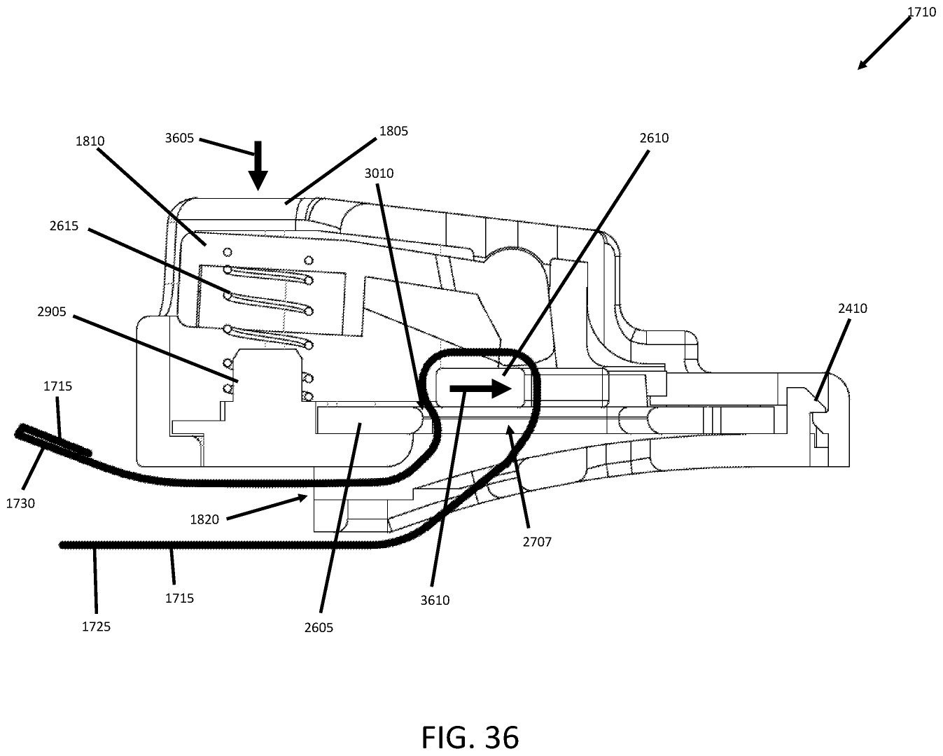

A cross-sectional view of the belt adjuster 1705 as taken along line 36-36 in FIG. 24 is shown in FIG. 36. FIG. 36 shows an example of how the tension belt 1725 is routed through the lever adjuster 1710. For example, the belt adjuster end 1730 of the tension belt 1725 is routed through the belt opening 1820 and then up through the window 2707 into the lever adjuster 1710. Once in the lever adjuster 1710, the belt adjuster end 1730 is wrapped around the belt bar 2610 and through the gap 3010. The belt adjuster end 1730 is then passed back through the belt opening 1820. As has been mentioned previously, the belt 1715 is squeezed and/or compressed between the frame 2605 and the belt bar 2610 to prevent movement of the belt 1715. However, applying force as shown by arrow 3605 to the trigger 1810 actuates the belt bar 2610 as shown by arrow 3610, thus enlarging the gap 3010 and enabling adjustment of the tension belt 1725 via the belt adjuster end 1730.

### GLOSSARY OF TERMS

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“About” with reference to numerical values generally refers to plus or minus 10% of the stated value. For example if the stated value is 4.375, then use of the term “about 4.375” generally means a range between 3.9375 and 4.8125.

“Acute” or “Acute Angle” generally refers to an angle smaller than a right angle or less than 90 degrees.

“And/Or” generally refers to a grammatical conjunction indicating that one or more of the cases it connects may occur. For instance, it can indicate that either or both of two stated cases can occur. In general, “and/or” includes any combination of the listed collection. For example, “X, Y, and/or Z” encompasses: any one letter individually (e.g., {X}, {Y}, {Z}); any combination of two of the letters (e.g., {X, Y}, {X, Z}, {Y, Z}); and all three letters (e.g., {X, Y, Z}). Such combinations may include other unlisted elements as well.

“Axis” generally refers to a straight line about which a body, object, and/or a geometric figure rotates or may be conceived to rotate.

“Belt Adjuster” generally refers to a belt, strap, and/or webbing adjustment mechanism that releases the hold of the mechanism on the belt for the purpose of releasing tension and/or lengthening the belt when actuated. Typically, but not always, the belt adjuster does not inhibit the belt from being shortened when the free end of the belt is pulled.

“Button” generally refers to a detachable fastener. A button is typically used to fasten two or more things together. Generally, a button works in conjunction with a buttonhole to secure items together. In one example, a button is used to secure two or more pieces of fabric together. Buttons may be a variety of shapes from rectangular, triangular, and/or circular to name a few. In other embodiments, a button may have a fanciful shape, such as an animal shape or the shape of an object. Generally, buttons work in conjunction with a buttonhole to secure items together.

“Child Safety Seat”, “Car Seat”, or “Child Restraint System” generally refer to a seat that is specifically designed to protect children from injury during a vehicle collision. Commonly, the child safety seat is an aftermarket product that is installed by an owner into a vehicle after purchase of the vehicle, but the child safety seat can be also integrated into a seat of the vehicle by a manufacturer of the vehicle. In contrast to most vehicle seats, which are designed to accommodate adults, the child safety seat is sized and configured to properly position a child or infant to reduce injury during an accident. The child safety further typically includes a passive restraint system, such as a harness, that generally hold an occupant of the seat in place during a collision. The restraint system for example can include a five-point harness, but other types of harnesses and restraints can be used. When sold as a separate, aftermarket product, the child safety seat can include an anchoring mechanism, like an Isofix connecter, configured to secure the child safety seat to the vehicle (e.g., via an Isofix anchor in the vehicle). Some typical types of child safety seats include infant seats, convertible seats, combination seats, and booster seats, just to name a few.

“Fastener” generally refers to a hardware device that mechanically joins or otherwise affixes two or more objects together. By way of non-limiting examples, the fastener can include bolts, dowels, nails, nuts, pegs, pins, rivets, screws, buttons, hook and loop fasteners, and snap fasteners, to just name a few.

“Frame” generally refers to a structure that forms part of an object and gives strength and/or shape to the object.

“Harness” generally refers to a set of straps and fittings for fastening a human or other animal in a particular place and/or position. The straps can come on many forms, such as belts, webbing, or ropes, and the straps can be made of a variety of materials such as natural or synthetic materials. The fittings are designed in a variety of forms for securing the straps around the individual as well as releasing the straps to free the individual. The harness can include webbing, buckles, latch plates, and/or length-adjustment mechanisms, such as a retractor. In one example, the fitting includes a set of latch plates that are secured in a buckle release mechanism. Harnesses can for instance be integrated into vehicle seats, child booster seats, and child safety seats. The straps and fitting can be configured in a number of manners such as to form three-point, five-point, and six-point harnesses, to name just a few examples.

“Isofix” or “ISOFIX” generally refers to an international standard for attachment points for child safety seats in passenger cars and other vehicles and/or attachment point or anchoring systems that satisfy the standard. More specifically, Isofix refers International Organization for Standardization (ISO) standard ISO 13216, which specifies the anchoring system for Group 1 child safety seats. This standard defines standard attachment points to be manufactured into cars, enabling compliant child safety seats to be quickly and safely secured. Isofix acts as an alternative to securing the seat with seat belts. In one form, child safety seats are secured with a single attachment at the top (e.g., top tether) and two attachments at the base of each side of the seat. The Isofix standard can be identified by other regional names. In the United States for example, the standard is commonly referred to as a LATCH (“Lower Anchors and Tethers for Children”) system.

“Lateral” generally refers to being situated on, directed toward, or coming from the side.

“Lever” generally refers to a simple machine including a beam, rod, or other structure pivoted at a fulcrum, such as a hinge. In one form, the lever is a rigid body capable of rotating on a point on itself. Levers can be generally categorized into three types of classes based on the location of fulcrum, load, and/or effort. In a class 1 type of lever, the fulcrum is located in the middle such that the effort is applied on one side of the fulcrum and the resistance or load on the other side. For class 1 type levers, the mechanical advantage may be greater than, less than, or equal to 1. Some non-limiting examples of class 1 type levers include seesaws, crowbars, and a pair of scissors. In a class 2 type of lever, which is sometimes referred to as a force multiplier lever, the resistance or load is located generally near the middle of the lever such that the effort is applied on one side of the resistance and the fulcrum is located on the other side. For class 2 type levers, the load arm is smaller than the effort arm, and the mechanical advantage is typically greater than 1. Some non-limiting examples of class 2 type levers include wheelbarrows, nutcrackers, bottle openers, and automobile brake pedals. In a class 3 type lever, which is sometimes referred to as a speed multiplier lever, the effort is generally located near the middle of the lever such that the resistance or load is on one side of the effort and the fulcrum is located on the other side. For class 3 type levers, the effort arm is smaller than the load arm, and the mechanical advantage is typically less than 1. Some non-limiting examples of class 3 type levers include a pair of tweezers and the human mandible.

“Lever Adjuster” generally refers to a belt, strap, and/or webbing adjustment mechanism that releases the hold of the mechanism on the belt for the purpose of releasing tension and/or lengthening the belt when a lever is pushed or otherwise actuated. Typically, but not always, the lever adjuster does not inhibit the belt from being shortened when the free end of the belt is pulled.

“Longitudinal” generally refers to the length or lengthwise dimension of an object, rather than across.

“Notch” generally refers to an indentation, cut, groove, channel, and/or incision on an edge or surface. In some non-limiting examples, the notch includes a V-shaped or U-shaped indentation carved, scratched, etched, stamped, and/or otherwise formed in the edge or surface. The notch can have a uniform shape or a non-uniform shape.

“Plastic” has the meaning, polymer or monomer material.

“Push Button Adjuster” generally refers to a belt, strap, and/or webbing adjustment mechanism that releases the hold of the mechanism on the belt for the purpose of releasing tension and/or lengthening the belt when a button is depressed. Typically, but not always, the pushbutton adjuster does not inhibit the belt from being shortened when the free end of the belt is pulled.

“Seat Belt”, “Safety Belt”, “Vehicle Belt”, or “Belt” generally refers to an arrangement of webs, straps, and other devices designed to restrain or otherwise hold a person or other object steady such as in a boat, vehicle, aircraft, and/or spacecraft. For example, the seat belt is designed to secure an occupant of a vehicle against harmful movement that may result during a collision or a sudden stop. By way of non-limiting examples, the seat belt can include webbing, buckles, latch plates, and/or length-adjustment mechanisms, such as a retractor, installed in the vehicle that is used to restrain an occupant or a child restraint system. The seat belt for instance can include a lap belt only, a combination lap-shoulder belt, a separate lap belt, a separate shoulder belt, and/or a knee bolster.

“Slide Adjuster” generally refers to hardware used to lock a belt at a fixed length using a single plate or at least a pair of plates with slots through which the belt is threaded in a prescribed manner. By way of non-limiting examples, the slide adjuster may use one slide with three slots or two slides with two slots each. Typically, but not always, the belt must be detached and the belt loops manually loosened to either shorten or lengthen the webbing.

“Snap Fastener” generally refers to a fastening device including a male portion and a female portion. The male portion typically includes a protrusion or ball on one component, while the female portion typically includes a recess or a socket configured to accept and secure the male portion. Typically, a snap fastener is mated together by a pushing force and separated by a pulling force.

“Snap-Fit Connector” or “Snap-Fit Connection” generally refers to a type of attachment device including at least two parts, with at least one of which being flexible, that are interlocked with one another by pushing the parts together. The term “Snap-Fit Connector” may refer to just one of the parts, such as either the protruding or mating part, or both of the parts when joined together. Typically, but not always, the snap-fit connector includes a protrusion of one part, such as a hook, stud, and/or bead, that is deflected briefly during the joining operation and catches in a depression and/or undercut in the mating part. After the parts are joined, the flexible snap-fit parts return to a stress-free condition. The resulting joint may be separable or inseparable depending on the shape of the undercut. The force required to separate the components can vary depending on the design. By way of non-limiting examples, the flexible parts are made of a flexible material such as plastic, metal, and/or carbon fiber composite materials. The snap-fit connectors can include cantilever, torsional, and/or annular type snap-fit connectors. In the annular snap-fit type connector, the connector utilizes a hoop-strain type part to hold the other part in place. In one form, the hoop-strain part is made of an elastic material and has an expandable circumference. In one example, the elastic hoop-strain part is pushed onto a more rigid part so as to secure the two together. Cantilever snap-fit type connectors can form permanent type connections or can be temporary such that the parts can be connected and disconnected multiple times. A multiple use type snap-fit connector typically, but not always, has a lever or pin that is pushed in order to release the snap-fit connection. For a torsional snap fit connector, protruding edges of one part are pushed away from the target insertion area, and the other part then slides in between the protruding edges until a desired distance is reached. Once the desired distance is reached, the edges are then released such that the part is held in place.

“Spring” generally refers to an elastic object that stores mechanical energy. The spring can include a resilient device that can be pressed, pulled, and/or twisted but returns to its former shape when released. The spring can be made from resilient or elastic material such as metal and/or plastic. The spring can counter or resist loads in many forms and apply force at constant or variable levels. For example, the spring can include a tension spring, compression spring, torsion spring, constant spring, and/or variable spring. The spring can take many forms such as by being a flat spring, a machined spring, and/or a serpentine spring. By way of nonlimiting examples, the springs can include various coil springs, pocket springs, Bonnell coils, offset coils, continuous coils, cantilever springs, volute springs, hairsprings, leaf springs, V-springs, gas springs, leaf springs, torsion springs, rubber bands, spring washers, and/or wave springs, to name just a few.

“Substantially” generally refers to the degree by which a quantitative representation may vary from a stated reference without resulting in an essential change of the basic function of the subject matter at issue. The term “substantially” is utilized herein to represent the inherent degree of uncertainty that may be attributed to any quantitative comparison, value, measurement, and/or other representation.

“Tilt-Lock Adjuster” generally refers to a belt, strap, and/or webbing adjustment mechanism that releases the hold of the mechanism on the belt for the purpose of releasing tension and/or lengthening the belt when the mechanism is lifted and/or held at an angle that is generally transverse to the general longitudinal direction of the belt. Typically, but not always, the tilt-lock adjuster does not inhibit the overall length of the belt from being shortened when the free end of the belt is pulled.

“Transverse” generally refers to things, axes, straight lines, planes, or geometric shapes extending in a non-parallel and/or crosswise manner relative to one another. For example, when in a transverse arrangement, lines can extend at right angles or perpendicular relative to one another, but the lines can extend at other non-straight angles as well such as at acute, obtuse, or reflex angles. For instance, transverse lines can also form angles greater than zero (0) degrees such that the lines are not parallel. When extending in a transverse manner, the lines or other things do not necessarily have to intersect one another, but they can.

“Web” or “Webbing” generally refers to a strap made of a network of thread, strings, cords, wires, and/or other materials designed to restrain or otherwise hold a person or other object steady such as in a boat, vehicle, aircraft, and/or spacecraft. By way of non-limiting examples, the web can be incorporated into a seat belt, a child booster seat, and/or a car seat.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

100 belt system
105 belt adjuster
110 lever adjuster
115 belt
120 fixed belt
125 tension belt
130 belt adjuster end
205 cover
210 trigger
215 belt mount
305 belt opening
1005 frame
1007 window
1010 belt bar
1015 pivot pins
1020 sockets
1025 spring
1030 shroud
1105 spring apertures
1200 retention assembly
1205 aperture
1305 notch
1310 posts
1315 arrow
1320 gap
1325 first end
1400 adjustment assembly
1402 lever
1405 bar engagement portion
1410 fulcrum
1502 coordinate system
1505 arrow
1510 arrow
1605 arrow
1610 arrow
1700 belt system
1705 belt adjuster
1710 lever adjuster
1715 belt
1720 fixed belt
1725 tension belt
1730 belt adjuster end
1805 cover
1810 trigger
1815 base
1820 belt opening
1905 belt mount
1910 sight window
2505 belt opening
2605 frame
2610 belt bar
2615 spring
2705 shroud
2707 window
2710 sockets
2715 pivot pins
2805 prongs
2905 mounting post
3000 adjustment assembly
3005 first end
3010 gap
3202 lever
3205 notch engagement portion
3210 notch
3215 posts
3220 fulcrum
3222 coordinate system
3225 arrow
3230 arrow
3305 prongs
3405 aperture
3410 prongs
3605 arrow
3610 arrow

What is claimed is:

1. A system, comprising:
a belt adjuster configured to secure and release a belt, wherein the belt adjuster includes
a frame,
a belt bar moveable relative to the frame to secure and release the belt, and
a lever coupled to the belt bar, wherein the lever is configured to
actuate the belt bar via a pivoting motion.

2. The system of claim 1, further comprising:
the belt;
wherein the belt is looped around the belt bar;
wherein the frame defines a window;
wherein the belt extends through the window in the frame;
wherein the belt is secured when the belt is compressed between the belt bar and the frame; and
wherein the belt is released when the belt bar and the frame are spaced apart to form a gap where the belt is able to slide.

3. The system of claim 1, wherein the lever includes:
a trigger where the lever is actuated;
a fulcrum where the lever pivots; and
a bar engagement portion configured to engage the belt bar.

4. The system of claim 3, wherein the trigger is configured to move parallel to a movement direction of the belt bar.

5. The system of claim 4, wherein the trigger is configured to move in an opposite direction from the movement direction of the belt bar.

6. The system of claim 3, wherein the trigger is configured to move perpendicular to a movement direction of the belt bar.

7. The system of claim 3, wherein the fulcrum is disposed between the trigger and the bar engagement portion.

8. The system of claim 7, wherein the trigger, the fulcrum, and the bar engagement portion are aligned in a substantially straight line along a longitudinal axis.

9. The system of claim 7, wherein the trigger extends transverse to the to the bar engagement portion.

10. The system of claim 3, further comprising:
wherein the fulcrum includes one or more pivot pins; and
a cover defining one or more sockets where the pivot pins are pivotally disposed.

11. The system of claim 3, wherein the belt bar defines a notch where the engagement portion of the lever is received.

12. The system of claim 11, wherein the cover has a shroud covering at least part of the trigger to inhibit accidental actuation of the lever.

13. The system of claim 3, further comprising:
a shroud disposed around the trigger to inhibit accidental actuation of the lever.

14. The system of claim 13, wherein the trigger is recessed in the shroud.

15. The system of claim 13, wherein the trigger is substantially flush with the shroud.

16. The system of claim 13, further comprising a spring biasing the lever to secure the belt.

17. The system of claim 1, wherein the lever is a type 1 lever.

18. A system, comprising:
a belt adjuster configured to secure and release a belt, wherein the belt adjuster includes
a frame,
a belt bar moveable relative to the frame to secure and release the belt,
a lever configured to actuate the belt bar to release the belt, wherein the lever has
a trigger,
a cover housing the frame and the belt bar, and
wherein the cover has a shroud covering at least part of the trigger
to inhibit accidental actuation of the lever.

19. The system of claim 18, wherein the trigger is recessed in the shroud.

20. The system of claim 18, wherein the trigger is substantially flush with the shroud.

21. The system of claim 18, wherein the spring biasing the lever to secure the belt.

22. The system of claim 18, wherein the lever has one or more pivot pins, and the cover defining one or more sockets where the pivot pins are pivotally disposed.

23. The system of claim 18, wherein the lever is straight.

24. The system of claim 18, wherein the lever is bent.

25. The system of claim 24, wherein the lever is L-shaped.

26. The system of claim 18, further comprising:
the belt;
wherein the belt is looped around the belt bar;
wherein the frame defines a window; and
wherein the belt extends through the window in the frame.

27. The system of claim 18, wherein the lever includes:
a fulcrum where the lever pivots; and
a bar engagement portion configured to engage the belt bar.

28. The system of claim 27, wherein the belt bar defines a notch where the engagement portion of the lever is received.

29. The system of claim 16, wherein the belt adjuster includes a sight window configured to enable visual confirmation of belt retention.
